(19) United States
(12) Patent Application Publication
(10) Pub. No.: US 2009/0115724 A1
(43) Pub. Date: May 7, 2009

(54) THREE-DIMENSIONAL OPERATION INPUT APPARATUS, CONTROL APPARATUS, CONTROL SYSTEM, CONTROL METHOD, METHOD OF PRODUCING A THREE-DIMENSIONAL OPERATION INPUT APPARATUS, AND HANDHELD APPARATUS

(75) Inventor: Kazuyuki Yamamoto, Kanagawa (JP)

Correspondence Address: K&L Gates LLP, P. O. BOX 1135, CHICAGO, IL, 60690, US

(73) Assignee: Sony Corporation, Tokyo (JP)

(21) Appl. No.: 12/256,268

(22) Filed: Oct. 22, 2008

(30) Foreign Application Priority Data
Oct. 22, 2007 (JP) 2007-274460
May 16, 2008 (JP) 2008-130096
Oct. 21, 2008 (JP) 2008-271255

(51) Int. Cl. G09G 5/08

(52) U.S. Cl. 345/158

(57) ABSTRACT

A three-dimensional operation input apparatus for controlling a pointer on a screen includes: a casing; a sensor for detecting a movement of the casing; a movement value calculation section for calculating, based on a detection value detected by the sensor, first and second movement values respectively corresponding to the movements of the casing in directions along first and second axes that are mutually orthogonal; and a modification section for calculating first and second modified movement values for respectively moving the pointer in first and second directions on the screen respectively corresponding to the first and second axes, the first modified movement value obtained by multiplying the first movement value by a first modification coefficient, the second modified movement value obtained by multiplying the second movement value by a second modification coefficient different from the first modification coefficient.

### CROSS REFERENCES TO RELATED APPLICATIONS

The present application claims priority to Japanese Patent Application JP 2007-274460 filed in the Japanese Patent Office on Oct. 22, 2007, Japanese Patent Application JP 2008-130096 filed in the Japanese Patent Office on May 16, 2008 and Japanese Patent Application JP 2008-271255 filed in the Japanese Patent Office on Oct. 21, 2008, the entire contents of which are being incorporated herein by reference.

### BACKGROUND

Pointing devices, particularly a mouse and a touchpad, are used as controllers for GUIs widely used in PCs (Personal Computers). Not just as HIs (Human Interfaces) of PCs as in related art, the GUIs are now starting to be used as an interface for AV equipment and game machines used in living rooms etc. with, for example, televisions as image media. Various pointing devices that a user is capable of operating three-dimensionally are proposed as controllers for the GUIs of this type (see, for example, Japanese Patent Application Laid-open No. 2001-56743 (paragraphs (0030) and (0031), FIG. 3; and Japanese Patent No. 3,748,483 (paragraphs (0033) and (0041), FIG. 1.

Japanese Patent Application Laid-open No. 2001-56743 discloses an input apparatus including angular velocity gyroscopes of two axes, that is, two angular velocity sensors. Each angular velocity sensor is a vibration-type angular velocity sensor. For example, upon application of an angular velocity with respect to a vibrating body piezoelectrically vibrating at a resonance frequency, Coriolis force is generated in a direction perpendicular to a vibration direction of the vibrating body. The Coriolis force is in proportion with the angular velocity, so detection of the Coriolis force leads to detection of the angular velocity. The input apparatus of Patent Document 1 detects angular velocities about two orthogonal axes by the angular velocity sensors, generates, based on the angular velocities, a signal as positional information of a cursor or the like displayed by a display means, and transmits the signal to the control apparatus.

Japanese Patent No. 3,748,483 discloses a pen-type input apparatus including three acceleration sensors (of three axes) and three angular velocity sensors (of three axes) (gyro). The pen-type input apparatus executes various types of operational processing based on signals obtained by the three acceleration sensors and the three angular velocity sensors, to obtain a positional angle of the pen-type input apparatus.

The following technique is disclosed as an apparatus for controlling a pointer based on information input by an input apparatus such as a joystick apparatus and not the three-dimensional operation input apparatus as described above (see, for example, Japanese Patent Application Laid-open No. 2004-348604 (paragraphs (0024) and (0033), FIG. 2.

According to the technique, when a user operates an operation lever of a joystick, for example, tilt angles (θ, φ) of the operation lever from a reference position, at which the operation lever is upright, are detected, and the tilt angles are converted into movement amounts of a cursor. The tilt angle θ is a tilt angle of the operation lever from a twelve o'clock position thereof, and the tilt angle φ is a tilt angle of the operation lever from the vertical direction. It should be noted that the control apparatus in this case calculates the tilt angles (θ, φ) using a detection principle that utilizes a trackball or an optical sensor used in general joysticks.

In particular, in the control apparatus of Japanese Patent Application Laid-open No. 2004-348604, a method of calculating movement amounts of a cursor involves multiplying movement vectors of the operation lever calculated based on the tilt angles by predetermined modification coefficients (α, β), or multiplying the movement vectors by a movement velocity S. When the movement vectors of the operation lever are multiplied by the movement velocity S, the calculated movement amounts of the cursor become large depending on the movement velocity S.

Incidentally, when the user moves the three-dimensional operation input apparatus, the user moves it in the air using a wrist or an arm. In this case, considering a bone structure of human beings, ease in swinging the wrist or arm in the air (hereinafter, referred to as operability) is hardly isotropic, and in terms of operation of the input apparatus, for example, the operability is particularly largely affected by a degree of freedom in moving a wrist of a dominant hand. In other words, considering the bone structure of human beings, the user can easily move the input apparatus in a certain direction but can hardly move the input apparatus in the other direction. Therefore, the pointer displayed on the screen is also affected by anisotropy in operability, and thus it becomes difficult to control the movement of the pointer with high precision.

Further, not only the bone structure but also gravity applied to the user's hand or arm that is moving the input apparatus affects the isotropy in operability. In other words, the operability differs between a case where the user moves the input apparatus against the gravity and a case where the user moves the input apparatus in a horizontal direction that is not affected by the gravity.

In view of the circumstances as described above, there is a need for a three-dimensional operation input apparatus, a control apparatus, a control system, a control method therefore, a method of producing a three-dimensional operation input apparatus, and a handheld apparatus that are capable of improving isotropy in operability and operational feeling of a user.

### SUMMARY

The present disclosure relates to a three-dimensional operation input apparatus, which is used to operate a GUI (Graphical User Interface), a control apparatus for controlling the GUI based on information output from the three-dimensional operation input apparatus, a control system including the three-dimensional operation input apparatus and the control apparatus, a control method, a method of producing a three-dimensional operation input apparatus, and a handheld apparatus.

According to an embodiment, there is provided a three-dimensional operation input apparatus controlling a pointer on a screen, including a casing, a sensor, a movement value calculation section, and a modification section.

The sensor detects a three-dimensional movement of the casing. The movement value calculation section calculates, based on a detection value detected by the sensor, a first movement value corresponding to the movement of the casing in a direction along a first axis and a second movement value corresponding to the movement of the casing in a direction along a second axis orthogonal to the first axis. The modification section calculates a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient.

In the embodiment, the first modified movement value and the second modified movement value respectively modified by the first modification coefficient and the second modification coefficient are calculated as movement values for moving the pointer on the screen. By setting the first modification coefficient and the second modification coefficient to be optimal values, anisotropy in operability caused by at least one of a bone structure of human beings, a gravitational effect, and a screen configuration can be suppressed, thus enhancing an operational feeling of the user.

The term “movement value” refers to various values regarding the movement of the casing, such as a velocity value, an acceleration value, an acceleration change rate, an angular velocity value, and an angular acceleration change rate.

Incidentally, depending on arrangement locations or positions of sensors included in the output means within the casing, sensitivities of the sensors differ even when the user moves the three-dimensional operation input apparatus in the same way. Therefore, in addition to the bone structure, the gravitational effect, and the screen configuration, the present application is also achieved regarding a difference in sensitivity that depends on the arrangement locations or positions of the sensors. In other words, the first modification coefficient and the second modification coefficient can be used to modify the sensor sensitivities that change when the sensors are disposed or positioned with deviation from the original arrangement locations or positions thereof, for example.

The expression “a second axis orthogonal to the first axis” only means that the first axis and the second axis need to be substantially orthogonal.

The movement value calculation section only needs to calculate the first movement value and the second movement value based on at least one of an acceleration and angular velocity of the casing, for example. When the first detection value and the second detection value are acceleration values, the first velocity value and the second velocity value only need to be calculated based on those acceleration values using, for example, an integration operation. When the first detection value and the second detection value include an acceleration value and an angular velocity value, a radius gyration of the movement of the casing may be obtained by dividing the acceleration value by the angular acceleration value. In this case, the velocity value can be obtained by multiplying the radius gyration by the angular velocity value. The radius gyration may be obtained by dividing the acceleration change rate by the angular acceleration change rate.

The sensor includes an acceleration sensor, an angular velocity sensor, a geomagnetic sensor, an image sensor, or a combination of at least two of those sensors.

In the three-dimensional operation input apparatus according to the embodiment, the movement value calculation section may calculate the second movement value while assuming that a gravity direction is the direction along the second axis, and calculate the first movement value while assuming that a direction perpendicular to the gravity direction is the direction along the first axis. In addition, the modification section may set the second modification coefficient to be larger than the first modification coefficient.

For example, when the user holds the three-dimensional operation input apparatus with a thumb on an upper side and a pinky at a lower side (hereinafter, referred to as reference position), the gravity direction is harder for the user to operate than a direction within a plane perpendicular thereto (hereinafter, expressed as “within a horizontal plane”). This is because at the reference position, considering a structure of joints including wrists, elbows, and the like, it is easier to move a hand or arm in the direction within a horizontal plane than the gravity direction. Alternatively, at the reference position, because gravity acts on the hand or arm in the gravity direction, there is an aspect that an operation of the user in the gravity direction is harder than that in the direction within a horizontal plane.

Specifically, the embodiment is attained based on at least one of the bone structure (mainly the joints of wrists and elbows) and the gravitational effect, or at least one of three perspectives including the two described above and a difference in sensitivity of the sensors caused by the difference in arrangement locations or positions thereof.

The term “calculate” refers to both cases where the values are calculated by an operation and where the various values to be calculated are stored in the memory or the like as the correspondence table so that the values are read out from the memory.

The term “perpendicular” means “substantially perpendicular” and does not necessarily have to be exactly perpendicular.

In the three-dimensional operation input apparatus according to the embodiment, the modification section may set, when the first direction on the screen is a lateral direction on the screen and the second direction on the screen is a longitudinal direction on the screen, the second modification coefficient to be larger than the first modification coefficient. For example, when the screen has an aspect ratio of 16:9 or less, the modification section sets the second modification coefficient to be larger than the first modification coefficient.

When the screen aspect ratio is 16:9 or less (e.g., 4:3), due to the bone structure and the gravitational effect, many people feel that an operation in the vertical direction is harder than that in the horizontal direction. In this case, the second modification coefficient is set to be larger than the first modification coefficient.

Meanwhile, when the screen aspect ratio is 2:1 or more, may people feel that an operation in the horizontal direction is harder than that in the vertical direction. In this case, the first modification coefficient is set to be larger than the second modification coefficient.

It should be noted, however, that the first modification coefficient and the second modification coefficient may be set optimally on a case-by-case basis since, in actuality, how a person might feel varies depending on a screen size, a distance between the input apparatus and the screen, the way the person is holding the casing, and so on.

In the three-dimensional operation input apparatus according to the embodiment, the movement value calculation section calculates the first movement value while assuming that a direction in which a width of the screen is longer is the direction along the first axis, and calculates the second movement value while assuming that a direction in which the width of the screen is shorter is the direction along the second axis, and the modification section sets the first modification coefficient to be larger than the second modification coefficient.

When values of the first modification coefficient and the second modification coefficient are the same, the three-dimensional operation input apparatus needs to be moved with larger motions when moving the pointer in a direction along long sides of the screen than when the pointer is moved in the direction in which the width of the screen is shorter, that is, the direction along short sides of the screen. Therefore, regarding the movement in the direction along long sides of the screen, the movement value calculation section calculates the first velocity value using the first modification coefficient larger than the second modification coefficient. Specifically, the embodiment is attained based on at least one of two perspectives including a configuration of the screen that displays the pointer and the difference in sensitivity of the sensors caused by the difference in arrangement locations or positions thereof.

The three-dimensional operation input apparatus according to the embodiment further includes a first compensation section to compensate a sensitivity variation of the sensor that is related to the calculation of the first movement value and the second movement value. Accordingly, it becomes possible to make effective use of the calculated modified movement values. The three-dimensional operation input apparatus according to the embodiment further includes an adjustment section to adjust at least one of the first modification coefficient and the second modification coefficient. Specifically, the user is capable of customizing the velocity values output from the three-dimensional operation input apparatus so that an ideal operational feeling can be obtained.

The three-dimensional operation input apparatus according to the embodiment may further include a second compensation section for compensating at least one of the first modified movement value and the second modified movement value in relation to a positional change of the casing with respect to a gravity direction. The positional change of the casing means that the user has changed the way of holding the casing, and thus due to a change of the direction in which the operability is higher in terms of the bone structure, the operational feeling of the user may be changed, and the first modified movement value and the second modified movement value calculated by the modification section may deviate from an optimal condition. Thus, by changing the modified movement values by the second compensation section, it becomes possible to compensate for the positional change of the casing. Accordingly, a favorable operational feeling for the user can be maintained.

The positional change of the casing with respect to the gravity direction can be detected using an acceleration sensor, for example. Alternatively, an acceleration sensor detecting an acceleration in a direction along a third axis perpendicular to an acceleration detection surface including the first axis and the second axis may be provided so that the acceleration sensor can be used to detect the positional change of the casing with respect to the gravity direction.

According to another embodiment, there is provided a control apparatus controlling a pointer on a screen in accordance with a detection value transmitted from a three-dimensional operation input apparatus that includes a casing and a sensor to detect a three-dimensional movement of the casing, including a reception section, a movement value calculation section, a modification section, and a coordinate information generation section.

The reception section receives the detection value. The movement value calculation section calculates, based on the detection value, a first movement value corresponding to the movement of the casing in a direction along a first axis and a second movement value corresponding to the movement of the casing in a direction along a second axis orthogonal to the first axis. The modification section calculates a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient. The coordinate information generation section generates coordinate information of the pointer on the screen in accordance with the first modified movement value and the second modified movement value.

Specifically, the control apparatus according to the embodiment calculates the first movement value and the second movement value based on the detection value of the sensor transmitted from the input apparatus, calculates the first modified movement value and the second modified movement value by respectively multiplying the first movement value and the second movement value by the first modification coefficient and the second modification coefficient, and generates the coordinate information of the pointer on the screen. Accordingly, it becomes possible to suppress anisotropy in operability caused by at least one of the bone structure, the gravitational effect, and the screen configuration, thus improving an operational feeling of the user.

According to another embodiment, there is provided a control apparatus controlling a pointer on a screen in accordance with a calculation value transmitted from a three-dimensional operation input apparatus that includes a casing, a sensor to detect a three-dimensional movement of the casing, and a movement value calculation section to calculate, based on a detection value detected by the sensor, a first movement value corresponding to the movement of the casing in a direction along a first axis and a second movement value corresponding to the movement of the casing in a direction along a second axis orthogonal to the first axis, the control apparatus including a reception section, a modification section, and a coordinate information generation section.

The reception section receives the calculation value. The modification section calculates a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient. The coordinate information generation section generates coordinate information of the pointer on the screen in accordance with the first modified movement value and the second modified movement value.

Specifically, the control apparatus according to the embodiment uses the first movement value and the second movement value transmitted from the input apparatus to calculates the first modified movement value and the second modified movement value, and generates the coordinate information of the pointer on the screen. Accordingly, it becomes possible to suppress anisotropy in operability caused by at least one of the bone structure, the gravitational effect, and the screen configuration, thus improving an operational feeling of the user.

The control apparatus according to the embodiment may further include an adjustment section to adjust at least one of the first modification coefficient and the second modification coefficient. Accordingly, the user becomes capable of customizing the velocity values output from the three-dimensional operation input apparatus so as to obtain an intuitional operational feeling.

According to another embodiment, there is provided a control system controlling a pointer on a screen, including a three-dimensional operation input apparatus and a control apparatus. The three-dimensional operation input apparatus includes a casing, a sensor, a movement value calculation section, a modification section, and a transmission section. The sensor detects a three-dimensional movement of the casing. The movement value calculation section calculates, based on a detection value detected by the sensor, a first movement value corresponding to the movement of the casing in a direction along a first axis and a second movement value corresponding to the movement of the casing in a direction along a second axis orthogonal to the first axis. The modification section calculates a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient. The transmission section transmits the first modified movement value and the second modified movement value as input information. The control apparatus includes a reception section and a coordinate information generation section. The reception section receives the input information. The coordinate information generation section generates coordinate information of the pointer on the screen in accordance with the first modified movement value and the second modified movement value.

According to another embodiment, there is provided a control system controlling a pointer on a screen, including a three-dimensional operation input apparatus and a control apparatus. The three-dimensional operation input apparatus includes a casing, a sensor, and a transmission section. The sensor detects a movement of the casing. The transmission section transmits a detection value detected by the sensor. The control apparatus includes a reception section, a movement value calculation section, a modification section, and a coordinate information generation section. The reception section receives the detection value. The movement value calculation section calculates, based on the detection value, a first movement value corresponding to the movement of the casing in a direction along a first axis and a second movement value corresponding to the movement of the casing in a direction along a second axis orthogonal to the first axis. The modification section calculates a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient. The coordinate information generation section generates coordinate information of the pointer on the screen in accordance with the first modified movement value and the second modified movement value.

According to another embodiment, there is provided a control system controlling a pointer on a screen, including a three-dimensional operation input apparatus and a control apparatus. The three-dimensional operation input apparatus includes a casing, a sensor, a movement value calculation section, and a transmission section. The sensor detects a three-dimensional movement of the casing. The movement value calculation section calculates, based on a detection value detected by the sensor, a first movement value corresponding to the movement of the casing in a direction along a first axis and a second movement value corresponding to the movement of the casing in a direction along a second axis orthogonal to the first axis. The transmission section transmits the values calculated by the movement value calculation section. The control apparatus includes a reception section, a modification section, and a coordinate information generation section. The reception section receives the calculation values. The modification section calculates a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient. The coordinate information generation section generates coordinate information of the pointer on the screen in accordance with the first modified movement value and the second modified movement value.

According to another embodiment, there is provided a control method including: outputting a first detection value by detecting a movement of a casing of a three-dimensional operation input apparatus in a direction along a first axis; outputting a second detection value by detecting the movement of the casing in a direction along a second axis orthogonal to the first axis; calculating, based on the first detection value and the second detection value, a first movement value corresponding to the movement of the casing in the direction along the first axis and a second movement value corresponding to the movement of the casing in the direction along the second axis; calculating a first modified movement value for moving a pointer in a first direction on a screen corresponding to the first axis, the first modified movement value obtained by multiplying the first movement value by a first modification coefficient; calculating a second modified movement value for moving the pointer in a second direction on the screen corresponding to the second axis, the second modified movement value obtained by multiplying the second movement value by a second modification coefficient different from the first modification coefficient; and generating coordinate information of the pointer on the screen in accordance with the first modified movement value and the second modified movement value.

According to another embodiment, there is provided a method of producing a three-dimensional operation input apparatus, including: storing, by a first storage section, a first modification coefficient that is multiplied by a first movement value calculated based on a detection value of a first sensor for detecting a movement of a casing in a direction along a first axis, the first movement value corresponding to the movement of the casing in the direction along the first axis, to thus calculate a first modified movement value for moving a pointer in a first direction on a screen corresponding to the first axis; storing, by a second storage section, a second modification coefficient different from the first modification coefficient, that is multiplied by a second movement value calculated based on a detection value of a second sensor for detecting the movement of the casing in a direction along a second axis orthogonal to the first axis, the second movement value corresponding to the movement of the casing in the direction along the second axis, to thus calculate a second modified movement value for moving the pointer in a second direction on the screen corresponding to the second axis; measuring a first detection sensitivity as a detection sensitivity of the first sensor and a second detection sensitivity as a detection sensitivity of the second sensor; and storing, respectively by a third storage section and a fourth storage section, a first gain and a second gain respectively multiplied to the first movement value and the second movement value for respectively adjusting the first detection sensitivity and the second detection sensitivity so that a difference between the first detection sensitivity and the second detection sensitivity becomes a predetermined value or less.

By measuring the first detection sensitivity and the second detection sensitivity and adjusting the sensitivities so that the difference therebetween becomes equal to or smaller than the predetermined value, the first modified movement value and the second modified movement value can be calculated effectively. Accordingly, it becomes possible to secure a movement operation of the pointer that matches the operational feeling of the user.

The method of producing a three-dimensional operation input apparatus according to the embodiment may further include: storing, by the first storage section, a value obtained by multiplying the first modification coefficient by the first gain; and storing, by the second storage section, a value obtained by multiplying the second modification coefficient by the second gain. In other words, the modified movement values may be calculated by multiplying the movement values by the values obtained by respectively multiplying the modification coefficients and the gains.

In the method of producing a three-dimensional operation input apparatus according to the embodiment, the first detection sensitivity may be measured by one of rotating and oscillating the casing about the second axis, and the second detection sensitivity may be measured by one of rotating and oscillating the casing about the first axis.

According to another embodiment, there is provided a handheld apparatus controlling a movement of a pointer displayed on a screen, including a casing, a display section, a sensor, a movement value calculation section, and a modification section. The display section displays the screen. The sensor detects a three-dimensional movement of the casing. The movement value calculation section calculates, based on a detection value detected by the sensor, a first movement value corresponding to the movement of the casing in a direction along a first axis and a second movement value corresponding to the movement of the casing in a direction along a second axis orthogonal to the first axis. The modification section calculates a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient.

Specifically, the handheld input apparatus having the display section formed integrally with the casing also bears the same effect as the above embodiments.

As described above, according to the embodiments, isotropy in operability of the three-dimensional operation input apparatus as well as the operation feeling of the user can be improved.

Additional features and advantages are described herein, and will be apparent from the following Detailed Description and the figures.

### BRIEF DESCRIPTION OF THE FIGURES

FIG. 1 is a diagram showing a control system according to an embodiment;

FIG. 2 is a perspective view showing an input apparatus;

FIG. 3 is diagram schematically showing an internal structure of the input apparatus;

FIG. 4 is a block diagram showing an electrical structure of the input apparatus;

FIG. 5 is a diagram showing an example of a screen displayed on a display apparatus;

FIG. 6 is a view showing a state where a user is holding the input apparatus;

FIG. 7 are diagrams for illustrating typical examples of ways of moving the input apparatus and ways a pointer moves on a screen;

FIG. 8 is a perspective view showing a sensor unit;

FIG. 9 is a flowchart showing an operation of the control system according to the embodiment;

FIG. 10 are diagrams for illustrating that operability of a user in moving the input apparatus is anisotropic in air;

FIG. 11 is a flowchart showing an operation of the control system in a case where a control apparatus carries out a main operation;

FIG. 12 is a flowchart showing an operation of the control system carried out so that the input apparatus can recognize a correct gravity direction in a case where the input apparatus is tilted from a reference position;

FIG. 13 are diagrams for illustrating a gravitational effect with respect to an acceleration sensor unit;

FIG. 14 shows an expression used for modifying velocity values by rotational coordinate conversion, and a diagram for illustrating such a case;

FIG. 15 is a flowchart showing an operation of the control system carried out when modifications using two modification coefficients based on two perspectives are carried out separately;

FIG. 16 is a flowchart showing a modification of the flowchart shown in FIG. 12;

FIG. 17 shows an expression used for modifying angular velocity values by rotational coordinate conversion, and a diagram for illustrating such a case;

FIG. 18 are diagrams showing cases where a main surface of a circuit board of the sensor unit is tilted with respect to a vertical surface as an absolute X-Y plane;

FIG. 19 show figures drawn in a user test using the input apparatus, in which FIG. 19A shows a case where the velocity values are not modified by modification coefficients and FIG. 19B shows a case where the velocity values are modified by the modification coefficients;

FIG. 20 is a diagram showing the screen during the user test in which the pointer is chasing markers that appear randomly;

FIG. 21 are diagrams each showing an example of a customization screen that uses a GUI as an example of an adjustment function of the modification coefficients;

FIG. 22 is a diagram showing a state of the user test in a case where modification coefficients that convert a movement amount ratio of X axis and Y axis detected by the input apparatus into an aspect ratio of the screen are set;

FIG. 23 are side views showing a process of a positional change of an input apparatus according to another embodiment;

FIG. 24 is a flowchart for illustrating a control example of the input apparatus shown in FIG. 23;

FIG. 25 shows a process flow for illustrating a method of producing the input apparatus according to the embodiment;

FIG. 26 is a diagram showing an amplifier circuit for amplifying an output of an angular velocity sensor as an example of a method of adjusting a sensitivity of an angular velocity sensor;

FIG. 27 is a diagram for illustrating a method of adjusting a gain of the amplifier circuit shown in FIG. 26;

FIG. 28 is a plan view showing a main portion of the angular velocity sensor as another example of the method of adjusting a sensitivity of an angular velocity sensor;

FIG. 29 are diagrams respectively showing examples of a sensitivity measurement method in a yaw direction and a pitch direction of the input apparatus;

FIG. 30 is a diagram showing another example of the sensitivity measurement method in the yaw direction and the pitch direction of the input apparatus;

FIG. 31 is a diagram showing another example of the sensitivity measurement method in the yaw direction and the pitch direction of the input apparatus;

FIG. 32 are diagrams respectively showing examples of angular velocity measurement data in the yaw direction and the pitch direction of the input apparatus; and

FIG. 33 shows a process flow for illustrating a calibration method of the input apparatus.

### DETAILED DESCRIPTION

Hereinafter, embodiments will be described with reference to the drawings.

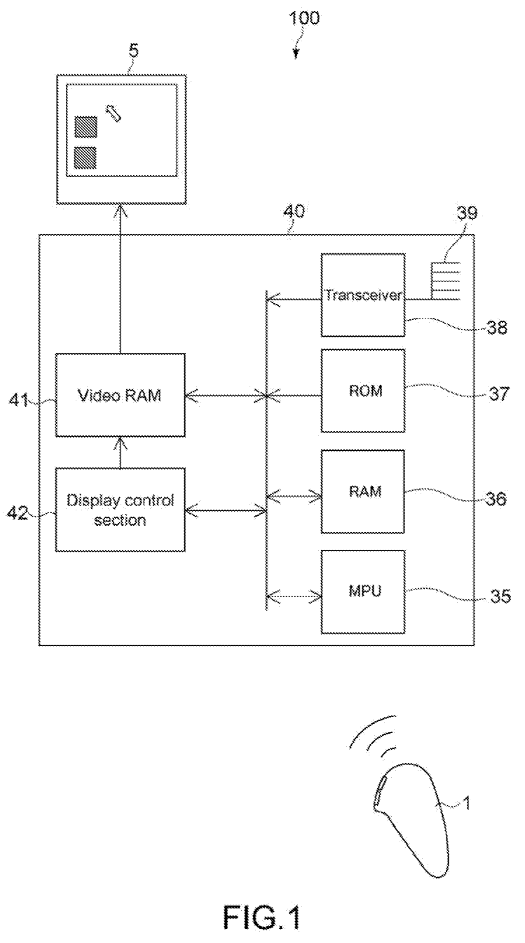

FIG. 1 is a diagram showing a control system according to an embodiment. A control system 100 includes a display apparatus 5, a control apparatus 40, and a three-dimensional operation input apparatus 1.

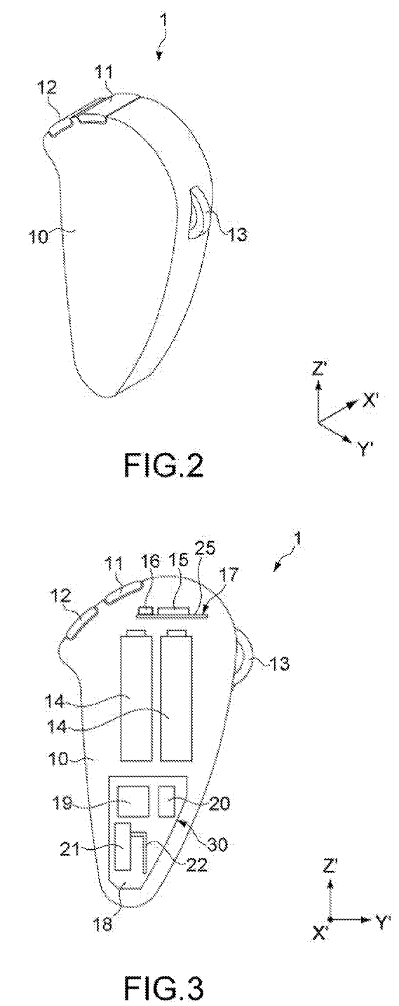

FIG. 2 is a perspective view showing the three-dimensional operation input apparatus 1. Hereinafter, the three-dimensional operation input apparatus will merely be referred to as input apparatus. The input apparatus 1 is of a size that a user is capable of holding. The input apparatus 1 includes a casing 10 and operation sections. The operation sections are, for example, two buttons 11 and 12 provided on an upper portion of the casing 10, and a rotary wheel button 13. The button 11 is disposed closer to the center of the upper portion of the casing 10 than the button 12. The button 11 functions as a left button of a mouse, that is, an input device for a PC. The button 12 is adjacent to the button 11 and functions as a right button of the mouse.

For example, a “drag and drop” operation may be executed by moving the input apparatus 1 while pressing the button 11. A file may be opened by double-clicking the button 11. Further, a screen 3 may be scrolled with the wheel button 13. Locations of the buttons 11 and 12 and the wheel button 13, a content of a command issued, and the like can arbitrarily be changed.

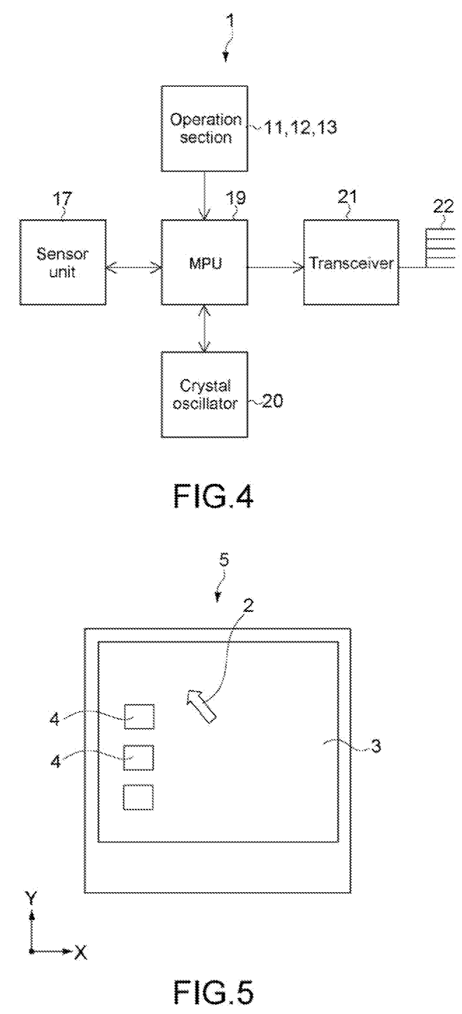

FIG. 3 is a diagram schematically showing an inner structure of the input apparatus 1. FIG. 4 is a block diagram showing an electrical structure of the input apparatus 1.

The input apparatus 1 includes a sensor unit 17, a control unit 30, and batteries 14.

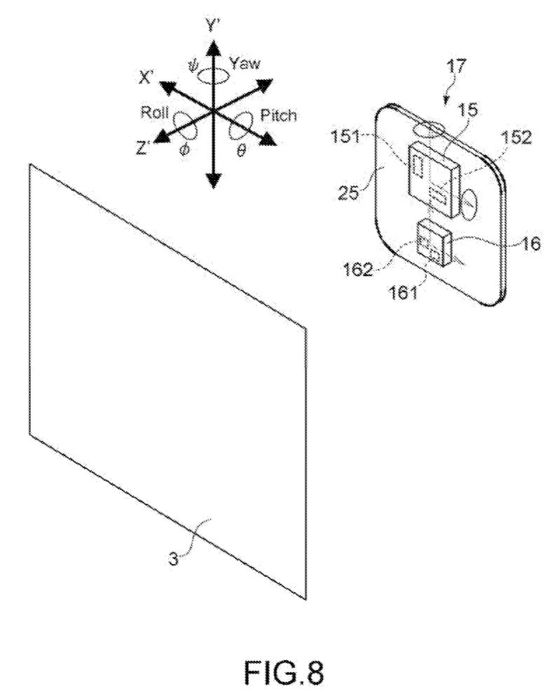

FIG. 8 is a perspective view showing the sensor unit 17 (detection means). The sensor unit 17 includes an acceleration sensor unit 16. The acceleration sensor unit 16 detects accelerations in different angles, e.g., along two orthogonal axes (X′ axis and Y′ axis). Specifically, the acceleration sensor unit 16 includes two sensors, that is, a first acceleration sensor 161 and a second acceleration sensor 162. The sensor unit 17 further includes an angular velocity sensor unit 15. The angular velocity sensor unit 15 detects angular accelerations about the two orthogonal axes. Specifically, the angular velocity sensor unit 15 includes two sensors, that is, a first angular velocity sensor 151 and a second angular velocity sensor 152. The acceleration sensor unit 16 and the angular velocity sensor unit 15 are packaged and mounted on a circuit board 25.

As each of the first angular velocity sensor 151 and the second angular velocity sensor 152, a vibration gyro sensor for detecting Coriolis force in proportion with an angular velocity is used. As each of the first acceleration sensor 161 and the second acceleration sensor 162, any sensor such as a piezoresistive sensor, a piezoelectric sensor, or a capacitance sensor may be used. Each of the first angular velocity sensor 151 and the second angular velocity sensor 152 is not limited to the vibration gyro sensor, and a rotary top gyro sensor, a ring laser gyro sensor, a gas rate gyro sensor, and the like may also be used.

In the description made with reference to FIGS. 2 and 3, a longitudinal direction of the casing 10 is referred to as Z′ direction, a thickness direction of the casing 10 is referred to as X′ direction, and a width direction of the casing 10 is referred to as Y′ direction, for convenience. In this case, the sensor unit 17 is incorporated into the casing 10 such that a surface of the circuit board 25 on which the acceleration sensor unit 16 and the angular velocity sensor unit 15 are mounted is substantially in parallel with an X′-Y′ plane. As described above, the acceleration sensor unit 16 and the angular velocity sensor unit 15 each detect physical amounts with respect to the two axes, that is, the X′ axis and the Y′ axis. In addition, a plane including the X′ axis (pitch axis) and the Y′ axis (yaw axis), that is, a plane substantially parallel to the main surface of the circuit board 25, is referred to as acceleration detection surface (hereinafter, will simply be referred to as detection surface). In the following description, a coordinate system that moves along with the input apparatus 1, that is, a coordinate system fixed to the input apparatus 1 is expressed using the X′ axis, Y′ axis, and Z′ axis, whereas a coordinate system stationary on earth, that is, an inertial coordinate system is expressed using the X axis, Y axis, and Z axis. Moreover, in the following description, with regard to a movement of the input apparatus 1, a rotational direction about the X′ axis is sometimes referred to as pitch direction, a rotational direction about the Y′ axis is sometimes referred to as yaw direction, and a rotational direction about the Z′ axis (roll axis) is sometimes referred to as roll direction.

The control unit 30 includes a main substrate 18, an MPU (Micro Processing Unit) 19 (or CPU) mounted on the main substrate 18, a crystal oscillator 20, a transceiver 21, and an antenna 22 printed on the main substrate 18.

The MPU 19 includes a built-in volatile or nonvolatile memory (storage means or storage section) requisite therefor. A detection signal output from the sensor unit 17, an operation signal output from the operation sections, and other signals are input to the MPU 19. The MPU 19 executes various types of operational processing to generate predetermined control signals in response to those input signals. The memory may be provided separate from the MPU 19. A DSP (Digital Signal Processor), an FPGA (Field Programmable Gate Array), or the like may be used instead of the MPU 19.

Typically, the sensor unit 17 outputs analog signals. In this case, the MPU 19 includes an A/D (Analog/Digital) converter. Alternatively, the sensor unit 17 may include the A/D converter.

The transceiver 21 (transmission means or transmission section) transmits control signals (input information) generated in the MPU 19 as RF radio signals to the control apparatus 40 via the antenna 22. Moreover, the transceiver 21 is also capable of receiving various signals transmitted from the control apparatus 40.

The crystal oscillator 20 generates clocks and supplies the clocks to the MPU 19. As the batteries 14, dry cell batteries, rechargeable batteries, or the like are used.

The control apparatus 40 is a computer and includes an MPU 35 (or CPU), a RAM 36, a ROM 37, a video RAM 41, a display control section 42, an antenna 39, and a transceiver 38.

The transceiver 38 (reception means or reception section) receives the control signal (input information) transmitted from the input apparatus 1 via the antenna 39. Moreover, the transceiver 38 is also capable of transmitting various predetermined signals to the input apparatus 1. The MPU 35 analyzes the control signal and executes various types of operational processing. Under control of the MPU 35, the display control section 42 generates screen data to be displayed on the screen 3 of the display apparatus 5. The video RAM 41 mainly serves as a work area of the display control section 42 and temporarily stores the generated screen data.

The control apparatus 40 may be an apparatus dedicated to the input apparatus 1, or may be a PC or the like. The control apparatus 40 is not limited to the PC, and may be a computer integrally formed with the display apparatus 5, an audio/visual device, a projector, a game device, a car navigation device, or the like.

Examples of the display apparatus 5 include a liquid crystal display and an EL (Electro-Luminescence) display, but are not limited thereto. The display apparatus 5 may alternatively be an apparatus integrally formed with a display and capable of receiving television broadcasts and the like.

FIG. 5 is a diagram showing an example of the screen 3 displayed on the display apparatus 5. On the screen 3, UIs such as icons 4 and a pointer 2 are displayed. The icons are images on the screen 3 representing functions of programs, execution commands, file contents, and the like of the computer. It should be noted that in the screen 3, the horizontal direction is referred to as X-axis direction and the vertical direction is referred to as Y-axis direction.

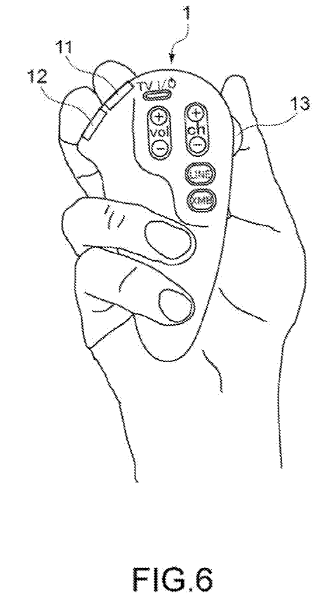

FIG. 6 is a diagram showing a state where a user is holding the input apparatus 1. As shown in FIG. 6, the input apparatus 1 may include operation sections including, in addition to the buttons 11 and 12 and the wheel button 13, various operation buttons such as those provided to a remote controller for operating a television or the like and a power switch, for example. When the user moves the input apparatus 1 in the air or operates the operation sections while holding the input apparatus 1 as shown in the figure, the input information is output to the control apparatus 40, and the control apparatus 40 controls the UI.

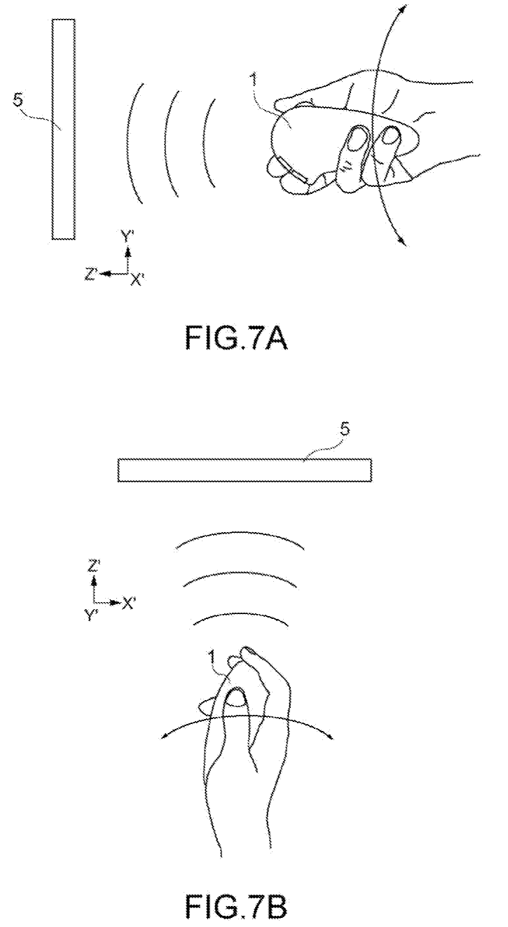

Subsequently, typical examples of ways of moving the input apparatus 1 and ways the pointer 2 moves on the screen 3 in response thereto will be described. FIGS. 7A and 7B are explanatory diagrams therefor.

As shown in FIGS. 7A and 7B, the user holds the input apparatus 1 so as to aim the buttons 11 and 12 side of the input apparatus 1 at the display apparatus 5. The user holds the input apparatus 1 such that a thumb is located on an upper side and a pinky is located on a lower side as in handshakes. In this state, the circuit board 25 (see FIG. 8) of the sensor unit 17 is substantially in parallel with the screen 3 of the display apparatus 5. Herein, the two axes as detection axes of the sensor unit 17 correspond to the horizontal axis (X axis) (pitch axis) and the vertical axis (Y axis) (yaw axis) on the screen 3, respectively. Hereinafter, the position of the input apparatus 1 as shown in FIGS. 7A and 7B is referred to as reference position.

As shown in FIG. 7A, in the state where the input apparatus 1 is in the reference position, the user swings a wrist or an arm in the vertical direction or the pitch direction. At this time, the second acceleration sensor 162 detects an acceleration (second acceleration) a_{y} in the Y′-axis direction and the second angular velocity sensor 152 detects an angular velocity (second angular velocity) ω_{θ} as an angle-related value about the X′ axis. Based on the detection values, the control apparatus 40 controls the display of the pointer 2 such that the pointer 2 moves in the Y-axis direction.

Meanwhile, as shown in FIG. 7B, in the state where the input apparatus 1 is in the reference position, the user swings the wrist or the arm in the horizontal direction or the yaw direction. At this time, the first acceleration sensor 161 detects an acceleration (first acceleration) aₓ in the X′-axis direction and the first angular velocity sensor 151 detects an angular velocity (first angular velocity) ω_{ψ} as the angle-related value about the Y′ axis. Based on the detection values, the control apparatus 40 controls the display of the pointer 2 such that the pointer 2 moves in the X-axis direction.

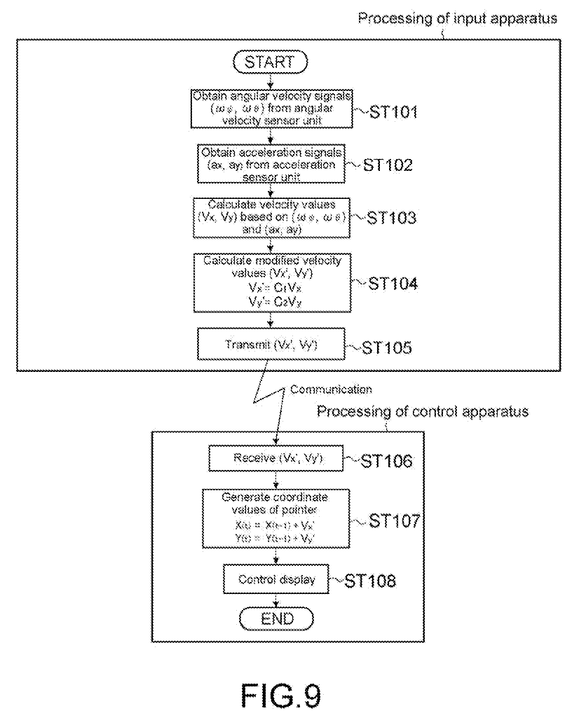

Next, descriptions will be given on an operation of the control system 100 structured as described above. FIG. 9 is a flowchart showing the operation.

First, power of the input apparatus 1 is turned on. For example, a power switch or the like provided to the input apparatus 1 or the control apparatus 40 is turned on by the user, to thereby turn on the power of the input apparatus 1. Upon turning on of the power, the angular velocity sensor unit 15 outputs biaxial angular velocity signals. The MPU 19 obtains the first angular velocity value ω_{ψ} and the second angular velocity value ω_{θ} from the biaxial angular velocity signals (Step 101).

Further, upon turning on of the power, biaxial acceleration signals are output from the acceleration sensor unit 16. The MPU 19 obtains a first acceleration value aₓ and a second acceleration value a_{y} from the biaxial acceleration signals (Step 102). The signals of the acceleration values are signals corresponding to the position of the input apparatus 1 at the time the power is turned on (hereinafter, referred to as initial position). It should be noted that the MPU 19 typically carries out Steps 101 and 102 in sync.

Hereinafter, descriptions will be given assuming that the initial position is the reference position.

Based on the acceleration values (aₓ, a_{y}) and angular velocity values (ω_{ψ}, ω_{θ}), the MPU 19 calculates velocity values (first velocity value Vₓ and second velocity value V_{y}) by a predetermined operation (Step 103) (movement value calculation means or movement value calculation section).

As a method of calculating the velocity values (Vₓ, V_{y}), there is a method in which the MPU 19 calculates the velocity values by integrating the acceleration values (aₓ, a_{y}), and the angular velocity values (ω_{ψ}, ω_{θ}) are used as an adjunct to the integration operation, for example.

Alternatively, the MPU 19 may calculate radius gyrations (R_{ψ}, R_{θ}) of the movement of the input apparatus 1 by dividing the acceleration values (aₓ, a_{y}) by angular acceleration values (Δω_{ψ}, Δω_{θ}). In this case, the velocity values (Vₓ, V_{y}) can be calculated by multiplying the radius gyrations (R_{ψ}, R_{θ}) by the angular velocity values (ω_{ψ}, ω_{θ}). The radius gyrations (R_{ψ}, R_{θ}) may also be calculated by dividing acceleration change rates (Δaₓ, Δa_{y}) by angular acceleration change rates (Δ(Δω_{ψ}),Δ(Δω_{θ})).

By calculating the velocity values using the above calculation methods, an operational feeling of the input apparatus 1 that matches an intuitional operation of the user can be obtained, and the movement of the pointer 2 on the screen 3 also matches the movement of the input apparatus 1 accurately. However, the velocity values (Vₓ, V_{y}) do not always have to be calculated by the above calculation methods. For example, the velocity values (Vₓ, V_{y}) may be calculated by simply integrating the acceleration values (aₓ, a_{y}).

The MPU 19 multiplies the calculated velocity values (Vₓ, V_{y}) by predetermined modification coefficients (Cₓ, C_{y}) for moving the pointer 2 on the screen 3. In other words, an operation using Equations (1) and (2) below is carried out to calculate modified velocity values (first modified velocity value Vₓ′ and second modified velocity value V_{y}′) (Step 104) (modification means or modification section).

Vₓ′=CₓVₓ (1)

V_{y}′=C_{y}V_{y} (2)

The modification coefficients (Cₓ, C_{y}) are real values that are arbitrarily set such that values of Cₓ and C_{y} differ from each other.

It should be noted that in the example above, the modified velocity values are calculated as modified movement values by multiplying the velocity values by the modification coefficients. However, movement values to be multiplied by the modification coefficients are not limited to the velocity values and may instead be angular velocity values, acceleration values, or other movement values related to the movement of the casing, such as time change rates of the angular velocity values or acceleration values. Therefore, the MPU 19 may calculate the modified movement values such as modified acceleration values or modified angular velocity values instead of the modified velocity values, and calculate the movement amount of the pointer based on the calculated values. For example, the MPU 19 can calculate the modified angular velocity values by multiplying the angular velocity values by the modification coefficients and multiply the modified angular velocity values by the radius gyrations of the input apparatus so as to use the calculated values as the velocity values for moving the pointer 2.

Next, the MPU 19 transmits information on the calculated modified velocity values (Vₓ′, V_{y}′) to the control apparatus 40 as input information using the transceiver 21 (Step 105).

The MPU 35 of the control apparatus 40 receives the information on the modified velocity values (Vₓ′, V_{y}′) (Step 106). The input apparatus 1 transmits the modified velocity values (Vₓ′, V_{y}′) every predetermined number of clocks, that is, per unit time. Thus, the control apparatus 40 can receive the modified velocity values (Vₓ′, V_{y}′) and obtain displacement amounts in the X- and Y-axis directions per unit time. Using Equations (3) and (4) below, the MPU 35 generates coordinate values (X(t), Y(t)) of the pointer 2 on the screen 3 that correspond to the obtained displacement amounts in the X- and Y-axis directions per unit time (Step 107). By generating the coordinate values, the MPU 35 controls display such that the pointer 2 moves on the screen 3 (Step 108) (coordinate information generation means or coordinate information generation section).

X(t)=X(t−1)+Vₓ (3)

Y(t)=Y(t−1)+V_{y} (4)

As described above, the modified velocity values (Vₓ′, V_{y}′) modified by the modification coefficients (Cₓ, C_{y}) are calculated as velocity values for moving the pointer 2 on the screen 3. By optimally setting the modification coefficients (Cₓ, C_{y}), it becomes possible to suppress anisotropy in operability caused by at least one of the following four perspectives, thus improving an operational feeling of the user, specific descriptions of which will be given hereinafter.

The four perspectives that rise when considering anisotropy in operability are as follows.

(1) Bone structure of wrists, arms, and the like of human beings

(2) Effect of gravity that acts on hands and arms of human beings

(3) Configuration of screen 3 (e.g., aspect ratio of screen 3)

(4) Arrangement location of sensor unit 17 (acceleration sensor unit 16 or angular velocity sensor unit 15) within casing 10

Now, descriptions will be given on merits of using the modification coefficients based on the perspective of (1) bone structure of wrists, arms, and the like of human beings described above.

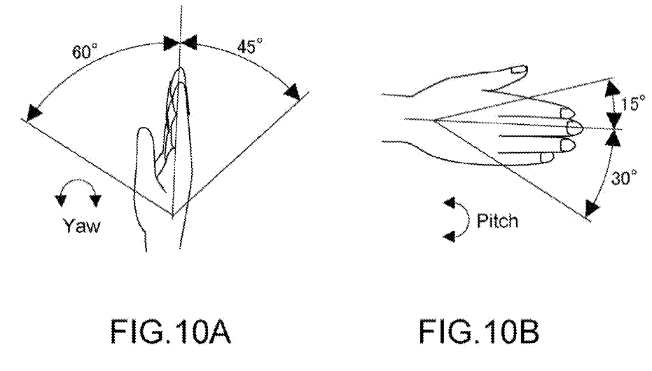

FIG. 10 are diagrams for illustrating that operability of the user in moving the input apparatus 1 is anisotropic in the air (reference: “Fitting the Task to the Man”, E. Grandjean, Taylor & Francis, 1980).

FIG. 10A shows an example where the hand of the user is waved laterally using a wrist as an axis while the palm and back of the hand are facing the lateral direction. The example of FIG. 10A corresponds to the example where the user moves the input apparatus 1 in the yaw direction using the wrist as an axis as shown in FIG. 7B. FIG. 10A shows that the user is capable of moving his/her hand by about 45° at maximum on a side of the back of the hand and by about 60° at maximum on a side of the palm.

FIG. 10B shows an example where the hand of the user is moved vertically using the wrist as an axis. The example of FIG. 10B corresponds to the example where the user moves the input apparatus 1 in the pitch direction using the wrist as an axis as shown in FIG. 7A. FIG. 10B shows that the user is capable of moving his/her hand by about 15° at maximum on a side of the thumb and by about 30° at maximum on a side of the pinky.

It can be seen from comparing FIGS. 10A and 10B that a movable range of a hand is larger in the example of FIG. 10A than in the example of FIG. 10B. In other words, it can be seen that it is harder for the user to move the input apparatus 1 in the pitch direction than the yaw direction as shown in FIG. 7. Therefore, when the coordinate values (X(t), Y(t)) of the pointer 2 on the screen 3 are generated directly from the received velocity values (Vₓ, V_{y}) by the control apparatus 40, for example, the user may have poor operability in moving the pointer 2 in the pitch direction than in the yaw direction. Specifically, even when the user thinks that he/she has moved the input apparatus 1 in the yaw and pitch directions by equal distances, the displacement amount of the pointer 2 on the screen 3 in the Y-axis direction tends to be smaller than that in the X-axis direction.

Thus, operability in the pitch direction is improved by respectively multiplying the velocity values (Vₓ, V_{y}) by modification coefficients (C₁, C₂) (C₁<C₂) as the modification coefficients (Cₓ, C_{y}). As a result, isotropy in operability of the user can be secured in both the yaw direction and the pitch direction. In other words, the user can feel isotropy in the way the pointer 2 moves in the X-axis direction on the screen 3 corresponding to the yaw direction and the Y-axis direction on the screen 3 corresponding to the pitch direction.

Values of C₁ and C₂ can be set arbitrarily. For example, C₂ may be set to be 1 to 2 times as large as C₁, or may be set otherwise. The values of C₁ and C₂ only need to be set through programming in advance. Alternatively, the input apparatus 1 may include a mechanical switch, a static switch, or the like such that the user can adjust the values of C₁ and C₂. Alternatively, the input apparatus 1 or the control apparatus 40 may include a program capable of adjusting the values of C₁ and C₂ using a GUI.

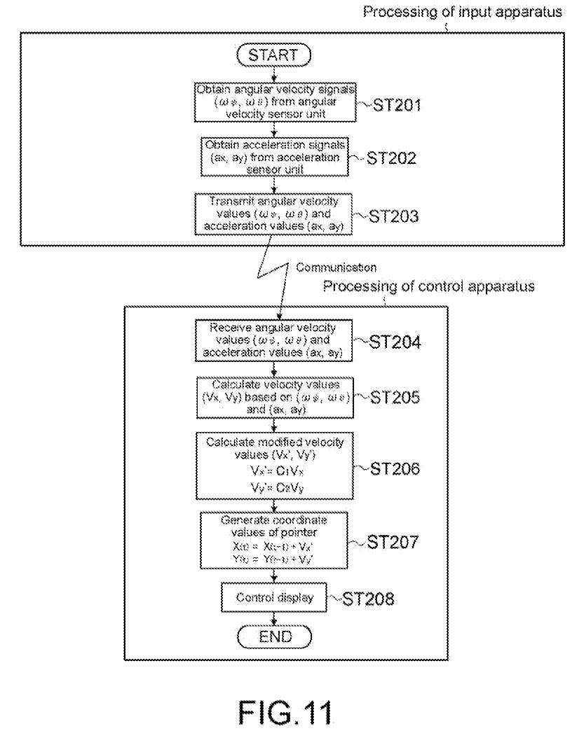

In FIG. 9, the input apparatus 1 calculates the modified velocity values (Vₓ′, V_{y}′) by carrying out the main operation. In an embodiment shown in FIG. 11, the control apparatus 40 carries out the main operation.

Processing of Steps 201 and 202 is the same as that of Steps 101 and 102. The input apparatus 1 transmits the biaxial acceleration values and biaxial angular velocity values output by the sensor unit 17 to the control apparatus 40 as input information (Step 203). The MPU 35 of the control apparatus 40 receives the input information (Step 204) and executes processing the same as that of Steps 103, 104, 107, and 108 (Steps 205 to 208).

Alternatively, the input apparatus 1 may calculate the velocity values (Vₓ, V_{y}) and transmit the values to the control apparatus 40 as the input information so that the control apparatus 40 calculates the modified velocity values (Vₓ′, V_{y}′) based on the received velocity values (Vₓ, V_{y}). After that, the control apparatus 40 executes the processing of Steps 207 and 208.

Next, descriptions will be given on merits of using the modification coefficients based on the perspective of (2) effect of gravity that acts on hands and arms of human beings described above.

The gravity that acts on the hand or arm of the user that moves the input apparatus 1 also affects isotropy in operability. In other words, operability differs between the case where the user raises the input apparatus 1 against the gravity and the case where the user moves the input apparatus 1 in the horizontal direction not affected by the gravity. A force against gravity is also required in the case where the input apparatus 1 is moved downward and sped down in addition to the case where the user raises the input apparatus 1.

Also in this case, the operability in the pitch direction is improved by respectively multiplying the velocity values (Vₓ, V_{y}) by the modification coefficients (Cₓ, C_{y}) (Cₓ<C_{y}) as the modification coefficients (Cₓ, C_{y}). As a result, isotropy in operability of the user can be secured in both the yaw direction and the pitch direction. In other words, the user can feel isotropy in the way the pointer 2 moves in both directions.

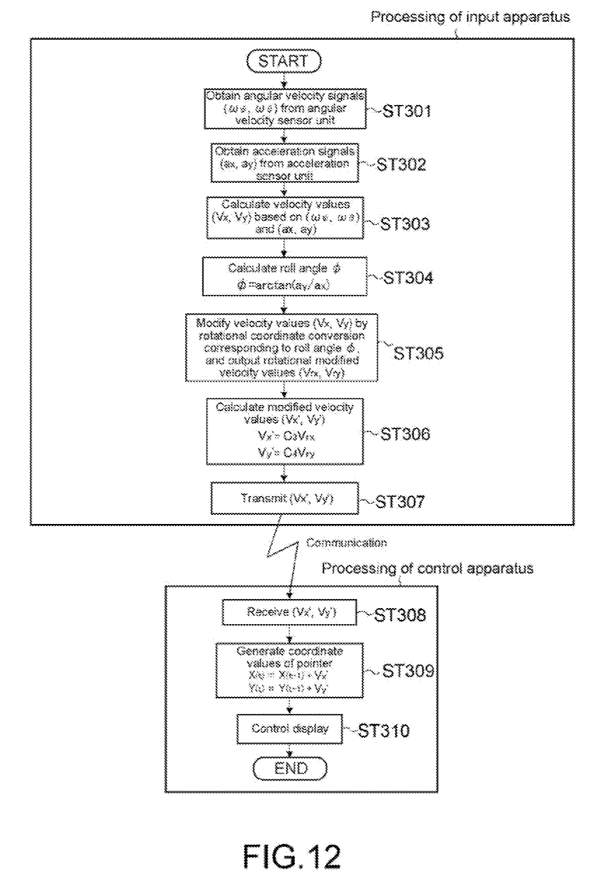

In particular, when the gravitational effect is taken into account, the input apparatus 1 needs to recognize the gravity direction. Therefore, when the input apparatus 1 is tilted from the reference position, for example, the input apparatus 1 executes the following processing to recognize the accurate gravity direction. FIG. 12 is a flowchart showing an operation of the control system 100 in this case.

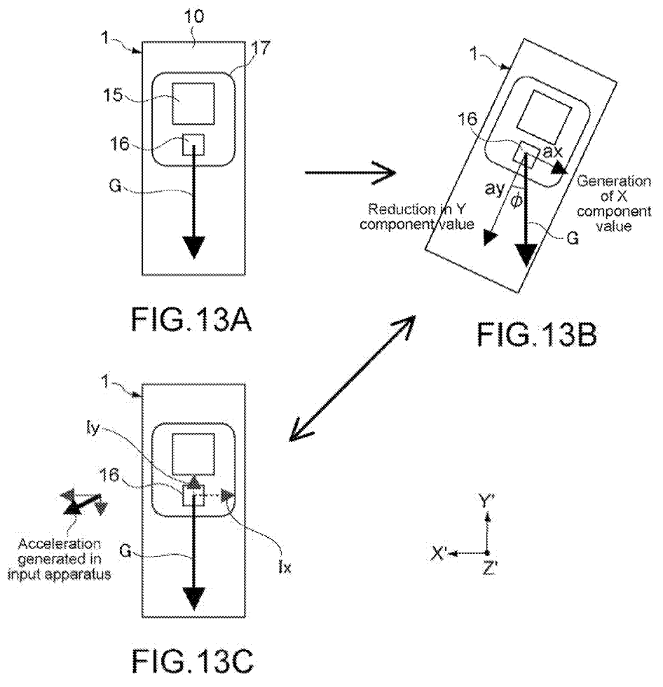

FIG. 13 are diagrams for illustrating the gravitational effect to the acceleration sensor unit 16. FIG. 13 each show the input apparatus 1 viewed in the Z-axis direction.

In FIG. 13A, the input apparatus 1 is held still at the reference position. At this time, an output of the first acceleration sensor 161 is substantially 0, and an output of the second acceleration sensor 162 corresponds to an amount of a gravity acceleration G. However, when the input apparatus 1 is tilted in the roll direction as shown in FIG. 13B, for example, the first acceleration sensor 161 and the second acceleration sensor 162 detect acceleration values of tilt components of the gravity acceleration G in the respective directions.

In this case, the first acceleration sensor 161 detects the acceleration in the X′-axis direction even when the input apparatus 1 is not actually moved in the yaw direction in particular. The state shown in FIG. 13B is equivalent to a state where, when the input apparatus 1 is in the reference position as shown in FIG. 13C, the acceleration sensor unit 16 has received inertial forces Ix and Iy as respectively indicated by arrows with broken lines, the states shown in FIGS. 13B and 13C being undistinguishable by the acceleration sensor unit 16. As a result, the acceleration sensor unit 16 judges that an acceleration in a downward left-hand direction as indicated by an arrow has been applied to the input apparatus 1 and outputs detection signals different from the actual movement of the input apparatus 1. In addition, because the gravity acceleration G constantly acts on the acceleration sensor unit 16, an acceleration integration value used for obtaining the velocity based on the acceleration is increased and an amount by which the pointer 2 is displaced in the downward oblique direction is increased at an accelerating pace. When the state is shifted from that shown in FIG. 13A to that shown in FIG. 13B, it is considered that inhibition of the movement of the pointer 2 on the screen 3 is an operation that intrinsically matches the intuition of the user.

To reduce the gravitational effect with respect to the acceleration sensor unit 16 as described above as much as possible, in the processing shown in FIG. 12, the input apparatus 1 calculates an angle in the roll direction and uses the calculated angle to modify the velocity values (Vₓ, V_{y}).

Processing of Steps 301 to 303 is the same as that of Steps 101 to 103.

Considered is a case where the input apparatus 1 is tilted in the roll direction as shown in FIG. 13B at the initial position thereof or thereafter.

The MPU 19 calculates a roll angle φ using Equation (5) below based on the gravity acceleration component values (aₓ, a_{y}) (Step 304) (angle calculation means).

φ=arctan(aₓ/a_{y}) (5)

The roll angle used herein refers to an angle formed between a resultant acceleration vector with respect to the X′- and Y′-axis directions and the Y′ axis (see FIG. 13B). A coordinate system of the X′ axis, the Y′ axis, and the Z′ axis is a coordinate system that moves in accordance with the movement of the input apparatus. In other words, the coordinate system is stationary with respect to the sensor unit 17. It should be noted that the values of the acceleration values (aₓ, a_{y}) and operational acceleration values (aₓᵢ, a_{yi}) are calculated as absolute values.

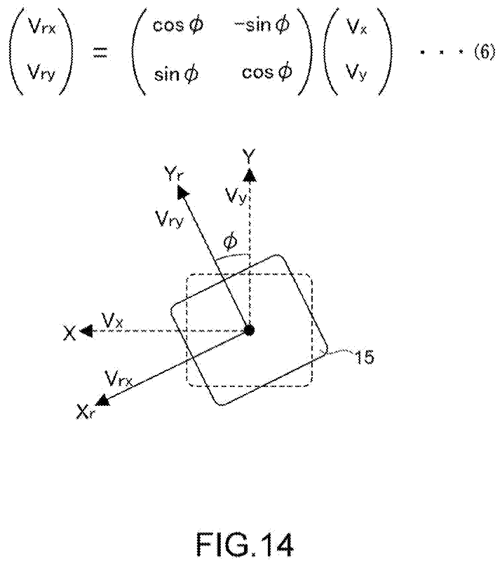

The MPU 19 modifies the velocity values (Vₓ, V_{y}) using rotational coordinate conversion corresponding to the calculated roll angle φ to thus obtain rotational modified velocity values (first rotational modified velocity value Vᵣₓ and second rotational modified velocity value V_{ry}) as modified values (Step 305) (rotation modification section). In other words, the MPU 19 uses Equation (6) of the rotational coordinate conversion shown in FIG. 14 to modify the velocity values (Vₓ, V_{y}) for output.

The MPU 19 calculates the modified velocity values (Vₓ′, V_{y}′) by respectively multiplying the rotational modified velocity values (Vᵣₓ, V_{ry}) by modification coefficients (C₃, C₄) (Step 306). Regarding the modification coefficients (C₃, C₄), C₃ and C₄ may be set to be equal to C₁ and C₂, respectively, or may be set to values other than C₁ and C₂. The values can suitably be changed.

Processing of Steps 307 to 310 is the same as that of Steps 105 to 108.

As in the processing shown in FIG. 11, the processing of Steps 304 to 306, 309, and 310 shown in FIG. 12 may be executed by the control apparatus 40, for example.

As described above, by modifying the velocity values (Vₓ, V_{y}) by the rotational coordinate conversion, the effect of the gravity acceleration components inadvertently detected by the acceleration sensor unit 16 can be removed. By calculating the modified velocity values (Vₓ′, V_{y}′) using the modification coefficients (C₃, C₄) after the gravity acceleration effect is removed, the velocity values that take the gravity direction into account are calculated appropriately.

In the processing shown in FIG. 12, the modified velocity values (Vₓ′, V_{y}′) are calculated by respectively multiplying, after the velocity values are modified by the rotational coordinate conversion corresponding to the roll angle φ, the rotational modified velocity values (Vᵣₓ, V_{ry}) by the modification coefficients (C₃, C₄).

However, as a modification of the processing shown in FIG. 12, the rotational modified velocity values may be calculated using the rotational coordinate conversion after the modified velocity values are calculated. In other words, the processing may be executed in the stated order of Steps 303, 306, 304, 305, and 307.

Whether to use the processing of FIG. 12 or the modification thereof mainly depends on the shape and merchantability of the input apparatus 1. For example, the latter is typically used in the case where an input apparatus is held and a roll angle thereof is almost fixed as in the input apparatus 1 shown in FIG. 2.

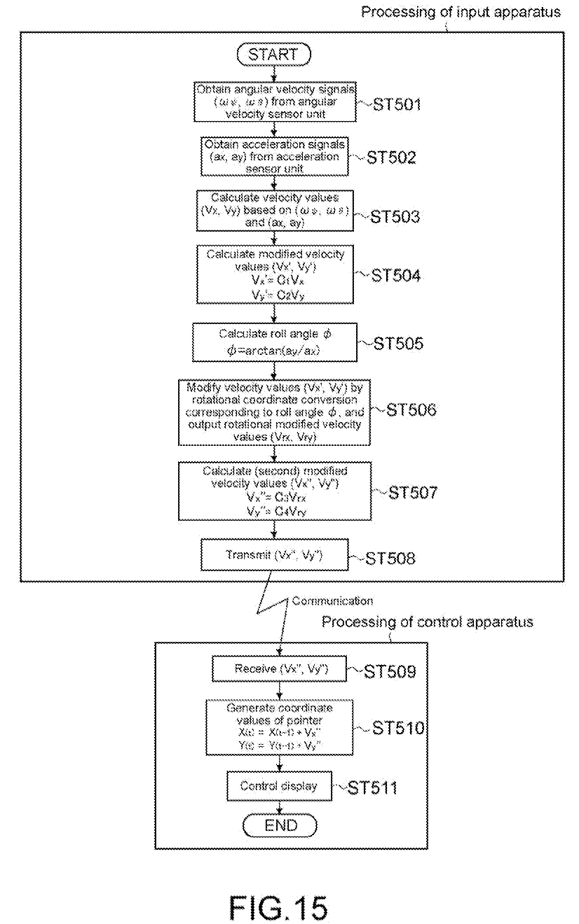

Alternatively, the input apparatus 1 may execute processing as shown in FIG. 15. The processing of Steps 501 to 504 is the same as that of Steps 101 to 104. The roll angle φ is calculated in Step 505, and the rotational coordinate conversion corresponding to the calculated roll angle φ is carried out in Step 506. In Step 507, the rotational modified velocity values (Vᵣₓ, V_{ry}) are respectively multiplied by the modification coefficients (C₃, C₄) to thus calculate second modified velocity values (Vₓ″, V_{y}″).

As described above, the modification using the modification coefficients (C₁, C₂) based on the perspective (1) above and the modification using the modification coefficients (C₃, C₄) based on the perspective (2) above may be carried out separately.

As in the processing shown in FIG. 11, the processing of Steps 504 to 507, 510, and 511 shown in FIG. 15 may be executed by the control apparatus 40, for example.

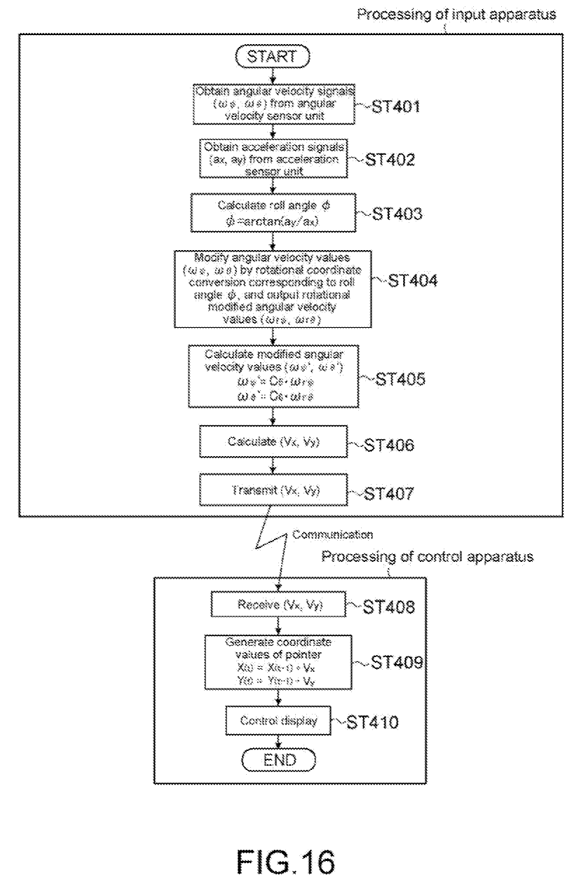

FIG. 16 is a flowchart showing a modification of the processing shown in FIG. 12. FIG. 16 shows an example where the angular velocity values (ω_{ψ}, ω_{θ}) detected by the angular velocity sensor unit 15 are modified by the rotational coordinate conversion.

The processing of Steps 401 to 403 is the same as that of Steps 301, 302, and 304.

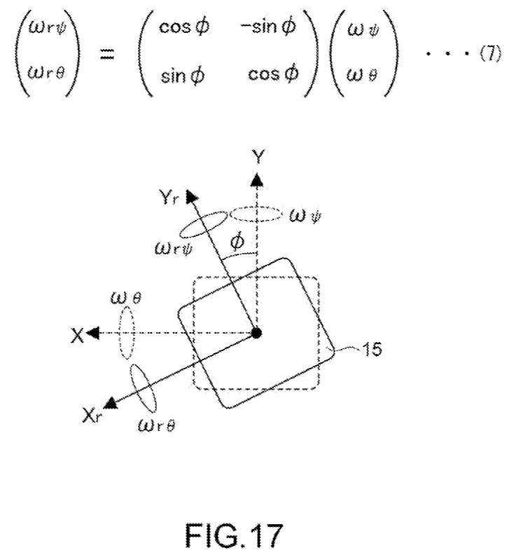

The MPU 19 modifies the angular velocity values (ω_{ψ}, ω_{θ}) using the rotational coordinate conversion of Equation (7) shown in FIG. 17 corresponding to the roll angle φ (Step 404). Accordingly, the MPU 19 outputs the rotational modified angular velocity values (ω_{rψ}, ω_{rθ}) The MPU 19 then respectively multiplies the rotational modified angular velocity values (ω_{rψ}, ω_{rθ}) by modification coefficients (C₅, C₆) to thus calculate modified angular velocity values (ω_{ψ}′, ω_{θ}′) (Step 405).

Regarding the modification coefficients (C₅, C₆), C₅ and C₆ may be set to be equal to C₃ and C₄, respectively, or may be set to values other than C₃ and C₄. The values can suitably be changed.

The MPU 19 calculates the velocity values (Vₓ, V_{y}) based on the modified angular velocity values (ω_{ψ}′, ω_{θ}′) (Step 406). As described above, for example, the processing of converting the angular velocity values into velocity values involves calculating the radius gyrations (R_{ψ}, R_{θ}) of the movement of the input apparatus 1 by dividing the acceleration values (aₓ, a_{y}) by the angular acceleration values (Δω_{θ}, Δω_{θ}), and multiplying the radius gyrations (R_{ψ}, R_{θ}) by the angular velocity values (ω_{ψ}, ω_{θ}) thereafter. As a result, the velocity values (Vₓ, V_{y}) can be obtained.

Processing of Steps 407 to 410 is carried out in the same manner as that of Steps 105 to 108.

As described above, in the processing shown in FIG. 12, the velocity values (Vₓ, V_{y}) are subjected to the modification using the rotational coordinate conversion. However, the processing shown in FIG. 16 bears the same effect as that shown in FIG. 12 even when the modification targets are the angular velocity values (ω_{ψ}, ω_{θ}).

As in the processing shown in FIG. 11, the processing of Steps 403 to 406, 409, and 410 shown in FIG. 16 may be executed by the control apparatus 40, for example.

Next, descriptions will be given on merits of using the modification coefficients based on the perspective of (3) configuration of screen 3 described above.

Examples of the aspect ratio (width:height ratio) of the screen 3 include a ratio of 16:9 or less like 4:3 and a ratio exceeding 2:1 like 8:3. In other words, the screen 3 is generally horizontally long. In the case where the screen aspect ratio is 16:9 or less, many users may feel that the operability of the pointer 2 is poorer in the Y-axis direction (vertical direction) than in the X-axis direction (horizontal direction) due to the bone structure and the gravitational effect. In this case, the modification coefficient in the Y-axis direction can be set to be larger than that in the X-axis direction as described above.

On the other hand, in the case where the screen aspect ratio is 2:1 or more, many users feel that the operability of the pointer 2 is poorer in the X-axis direction than in the Y-axis direction. In such a case, opposite to the case described above, the modification coefficient in the X-axis direction can be set to be larger than that in the Y-axis direction. Thus, in a case where the movement amount of the pointer 2 in the X-axis direction is set to be larger than that in the Y-axis direction, modification coefficients (C₇, C₈) (C₇>C₈) may respectively be multiplied to the velocity values (Vₓ, V_{y}).

Thus, when the user moves the input apparatus 1 similarly in the X- and Y-axis directions, the displacement amount of the pointer 2 in the X-axis direction can be made larger than that in the Y-axis direction, thereby improving the operational feeling of the user.

Regarding the modification coefficients (C₇, C₈), C₇ and C₈ may be set to be equal to C₁ and C₂, respectively, or may be set to values other than C₁ and C₂. The values can suitably be changed. Alternatively, as the modification coefficients (C₇, C₈), C₇ may be set to be smaller than C₈ in a case of a vertically long screen.

Incidentally, because the user can easily move the input apparatus 1 in the X-axis direction, the input apparatus 1 of the embodiment as shown in FIGS. 2 and 3 nonproblematic from the perspective of the configuration of the screen 3. However, when the input apparatus 1 is held in a way a user normally holds a mouse used on a plane, the user feels that it is hard to move the input apparatus 1 in the X-axis direction. Thus, this embodiment is effective in such a case.

Next, descriptions will be given on merits of using the modification coefficients based on the perspective of (4) arrangement location of sensor unit 17 within casing 10 described above.

For example, as shown in FIG. 7, even when the user thinks he/she is holding the input apparatus 1 in the reference position, the main surface of the circuit board 25 of the sensor unit 17 may tilt from the vertical surface as an absolute X-Y plane depending on the way the user is holding the input apparatus 1.

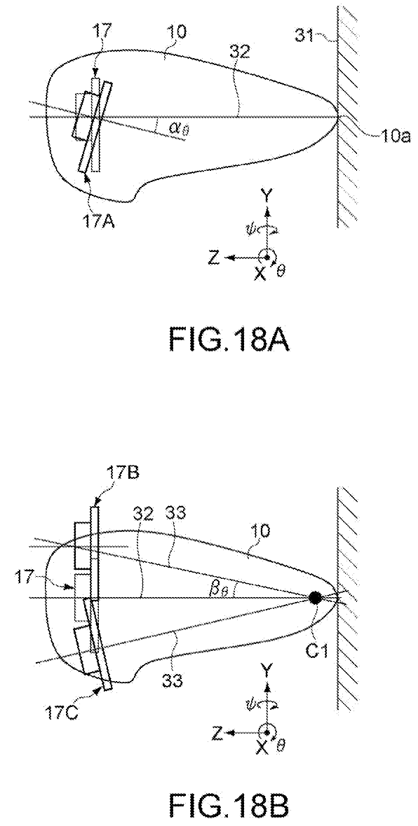

Alternatively, there may be a case as shown in FIG. 18A. FIG. 18A focuses on, for example, a vertical line 32 of a virtual plane 31 that is in contact with an apex section 10a at a rear end of the casing 10 of the input apparatus 1. As illustrated by a sensor unit 17A, there may be a case where the sensor unit is disposed within the casing 10 without the main surface of the circuit board 25 being vertical to the vertical line 32. Alternatively, there may also be a case where the angular velocity sensor unit 15 or the acceleration sensor unit 16 is mounted to the circuit board 25 without the main surface of the sensor unit 15 or 16 (acceleration detection surface to be described later) being vertical to the vertical line 32 even when the main surface of the circuit board 25 is vertical to the vertical line 32.

It should be noted that in FIG. 18A, the sensor unit 17A is illustrated with an extremely large tilt for ease in comprehension of descriptions.

Alternatively, there may be a case as shown in FIG. 18B, that is, a case where a surface in the vicinity of a rear end section 10b of the casing 10 is a curved surface such as a partial sphere. In this case, an ideal shape is a shape in which, among a plurality of lines extending from a center C1 of the sphere, the vertical line 32 passes substantially a center or barycenter of the sensor unit 17. However, there may be a case where the sensor unit 17B is disposed within the casing 10 such that, among the plurality of lines extending from the center C1, a line 33 different from the vertical line 32 passes the center or barycenter of the sensor unit 17B. Alternatively, as illustrated by a sensor unit 17C, there may be a composite deviation of the sensor unit 17A shown in FIG. 18A and the sensor unit 17B shown in FIG. 18B.

It should be noted that in FIG. 18B, the arrangement locations of the sensor units 17B and 17C are deviated largely for ease in comprehension of descriptions.

In the descriptions hereinafter, the deviation of the main surface of the sensor unit 17A (angular velocity sensor unit 15 or acceleration sensor unit 16) as shown in FIG. 18A from the vertical surface (plane 31) is referred to as angular deviation. An angle of the angular deviation is represented by α. The deviation of the arrangement location of the sensor unit 17B (angular velocity sensor unit 15 or acceleration sensor unit 16) as shown in FIG. 18B from the vertical line 32 is referred to as positional deviation. An angle of the non-vertical line 33 from the vertical line 32 is represented by β.

FIG. 18A shows the example where the angular deviation of the sensor unit 17A is generated about the X axis, that is, in the pitch direction. However, there may be a case where the angular deviation is generated about the Y axis, that is, in the yaw direction. Similarly, although FIG. 18B shows the example where the positional deviation of the sensor unit 17B (or 17C) is generated in the pitch direction, there may be a case where the positional deviation is generated in the yaw direction. Therefore, (α_{ψ}, α_{θ}) can be defined as component values of the angular deviation α in the yaw and pitch directions. Moreover, (β_{ψ}, β_{θ}) can be defined as component values of the positional deviation β in the yaw and pitch directions.

When the angular deviation or positional deviation as described above is generated, desired angular velocity values or acceleration values may not be detected even when the user moves the input apparatus 1 from the reference position. Therefore, in principle, a sensitivity deviation of the sensor unit 17 caused by the angular deviation is modified by Equations (8) to (11) below, and a sensitivity deviation of the sensor unit 17 caused by the positional deviation is modified by Equations (12) to (15) below.

a_{cx}=aₓ*cos α₁₀₄ (8)

a_{cy}=a_{y}*cos α_{θ} (9)

ω_{cψ}=ω_{ψ}*cos α₁₀₄ (10)

ω_{cθ}=ω_{θ}*cos α_{θ} (11)

a_{cx}=aₓ*cos β₁₀₄ (12)

a_{cy}=a_{y}*cos β_{θ} (13)

ω_{cψ}=ω_{ψ}*cos β₁₀₄ (14)

ω_{cθ}=ω_{θ}*cos β_{θ} (15)

(a_{cx}, a_{cy}) are acceleration values in the X- and Y-axis directions that have been modified, and (ω_{cψ}, ω_{cθ}) are angular velocity values in the yaw and pitch directions that have been modified. (aₓ, a_{y}) are acceleration detection values of the acceleration sensor unit 16, and (ω_{ψ}, ω_{θ}) are angular velocity detection values of the angular velocity sensor unit 15.

It is also possible that, at the time the user actually uses the input apparatus 1, the input apparatus 1 or the control apparatus 40 calculates the angles (α_{ψ}, α_{θ}) of the angular deviation or the angles (β_{ψ}, β_{θ}) of the positional deviation by an operation, and modifies the sensitivity deviation of the sensor unit 17 using Equations (8) to (15). However, the sensitivity deviation generated as described above can be modified by modifying the velocity values using the modification coefficients.

In this case, the control system 100 only needs to execute processing similar to that shown in FIG. 9. It is only necessary that (C₉, C₁₀) be set as the modification coefficients in Step 104, for example. Regarding the modification coefficients (C₉, C₁₀), C₉ and C₁₀ may be set to be equal to C₁ and C₂, respectively, or may be set to values other than C₁ and C₂. The values can suitably be changed.

The MPU 19 may store the gains in the X- and Y-axis directions (first and second gains) for compensating the sensitivity deviation (sensitivity variation) of the sensor unit 17 in advance (first compensation means or first compensation section). The MPU 19 can compensate the sensitivity deviation by respectively multiplying the velocity values by those gains. Moreover, the MPU 19 may store in advance products of the gains and the modification coefficients, for compensating the sensitivity deviation. Accordingly, the modified velocity values having the sensitivity deviation compensated can be calculated by a single operation. The first and second gains may be stored in the same storage section or may be stored separately in difference storage sections. Furthermore, the first and second gains may be stored in the same storage section or different storage sections as products of the first and second gains with the first and second modification coefficients, respectively.

Alternatively, the MPU 19 may store in the storage section gains that compensate, instead of or in addition to the sensitivity deviation, the sensitivity difference between the first and second angular velocity sensors 151 and 152 (or first and second acceleration sensors 161 and 162) (first compensation means or first compensation section). Accordingly, the calculated modified velocity values can be used effectively.

In the operation described above with reference to FIG. 9, 11, 12, or 15, the MPU 19 may calculate the roll angle φ in sync with the calculation of the velocity values (Vₓ, V_{y}), or calculate the roll angle φ every time the plurality of velocity values (Vₓ, V_{y}) are calculated.

Next, descriptions will be given on a modification coefficient setting method described above. There are the following two ways (A) and (B) in carrying out the modification coefficient setting method in this case.

(A) A method of setting certain modification coefficients in advance at the time of production of the input apparatus 1 or the control apparatus 40

(B) A method in which default modification coefficients are set at the time of production of the input apparatus 1 or the control apparatus 40, and a user customizes the modification coefficients when using the control system 100

First, descriptions will be given on the method in which a manufacturer sets certain default modification coefficients at the time of production of the input apparatus 1 or the control apparatus 40 in one of two ways of (A) and (B).

The inventors of the present application have conducted a user test for obtaining the modification coefficients in the X- and Y-axis directions, and thus obtained average modification coefficients.

Examples of the user test include the following methods, for example.

(a) A target user of the test operates the input apparatus 1 and draws a square without looking at the screen 3.

(b) The target user operates the input apparatus 1 and draws a circle without looking at the screen 3.

(c) The target user operates the input apparatus 1 and draws a line segment with an angle of 45° without looking at the screen 3.

(d) The target user swings the input apparatus 1 at a most favorable velocity in both the X- and Y-axis directions.

(e) The target user operates the input apparatus 1 and intuitively points to a marker that randomly appears on the screen 3 so as to chase the marker.

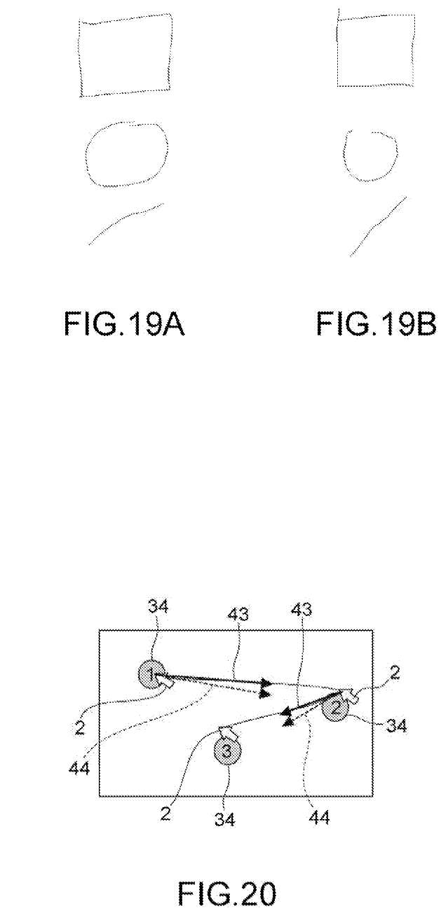

By the methods (a) to (c) above, by the target user of the test drawing a figure in a state where no visual feedback is provided, a deviation between the sense of the user and the actual movement is recognized. FIG. 19 are diagrams each showing figures drawn in the test using the methods (a) to (c). FIG. 19A shows a case where the velocity values are not modified by the modification coefficients, and FIG. 19B shows a case where the velocity values have been modified by the modification coefficients (Cₓ, C_{y}). In FIG. 19B, the modification coefficients (Cₓ, C_{y}) are set so as to establish, for example, C_{y}=(8/7)Cₓ. Such a difference is probably largely due to at least one of the perspectives (1) and (2) among the four perspectives that rise when considering anisotropy in operability. As is apparent from the figures, the deviation between the sense of the user and the actual movement is modified by appropriate modification coefficients.

Meanwhile, the method (d) above is used to directly recognize a proper movement amount ratio of the pointer 2 on the X axis and Y axis.

Further, by fast intuitive pointing operations made by the target user in the method (e) above, the modification movement amount ratio can be detected based on the deviation between a proper trajectory and an actual trajectory of the pointer 2. FIG. 20 is a diagram of the screen 3 showing a state of the test that does not use modification coefficients. In FIG. 20, a marker 34 randomly appears in the order of 1, 2, and 3, and the pointer 2 is operated so as to chase the marker 34.

Vectors 44 indicated by broken lines each indicate a direction of a vector that the target user of the test is targeting (line that passes a center of the marker 34). Vectors 43 indicated by solid lines each indicate a direction of a vector obtained when the pointer 2 is actually moved. As described above, a difference in direction is generated between the sense of the target user (vectors 44 indicated by broken lines) and the actual movement (vectors 43 indicated by solid lines). This is because, based on the perspectives (1) and (2) above, the target user can move the input apparatus in the lateral direction more easily than the vertical direction.

In the case of the test shown in FIG. 20, it is only necessary that the modification coefficients (Cₓ, C_{y}) with which a vector, that is newly obtained by multiplying the X component or Y component of the actual vector 43 indicated by the solid line by the corresponding modification coefficient (Cₓ or C_{y}), averagely overlaps the vector 44 indicated by the broken line be calculated.

In addition, as the method of setting certain or default modification coefficients, there is a method of setting modification coefficients in accordance with a ratio of the screen based on the perspective (3) above. For example, when the aspect ratio of the screen 3 is 4:3, the ratio of C₇:C₈ only needs to be about 3:4 as the modification coefficients. Alternatively, when the aspect ratio of the screen 3 is 16:9, the ratio of C₇:C₈ only needs to be about 9:16 as the modification coefficients.

Next, descriptions will be given on the method (B) in which the modification coefficients are set by customization of the modification coefficients by regular users.

If regular users can customize the values of the modification coefficients, operations of the input apparatus 1 that match the characteristics of the individual users become possible. As the customization method, there is a method in which the control system 100 carries out a test using the methods (a) to (e) above. In this case, the test may be carried out through interactions between the user and the control system 100 (interactions held while displaying a GUI on the display apparatus 5).

Alternatively, as another customization method, the input apparatus 1 or the control apparatus 40 may include a function of adjusting the modification coefficients (Cₓ, C_{y}) (adjustment means or adjustment section). Examples of one adjustment function include a mechanical switch (e.g., DIP switch, button switch, and dial switch), a static switch, or other switches provided to the casing 10 of the input apparatus 1 or a casing of the control apparatus 40.

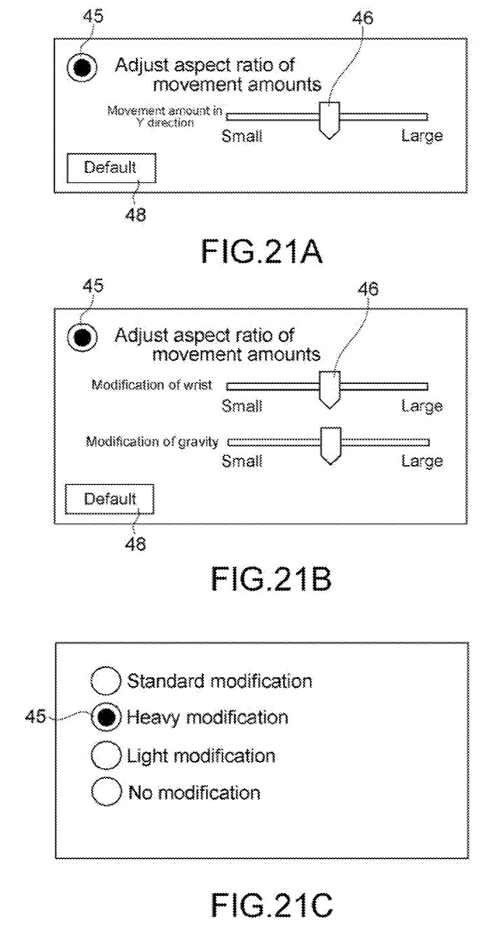

An example of another adjustment function is software that uses a GUI. FIG. 21 each show an example of a customization screen.

FIG. 21A shows an example of an adjustment screen used for adjusting a ratio of a movement amount of the input apparatus 1 in the Y-axis direction with respect to that in the X-axis direction. For example, by the toggle 45 being marked by an operational input of the user to the control system 100, the user becomes capable of operating a level control 46 in the lateral direction. The toggle 45 is marked by an operational input of the user made by clicking using the input apparatus 1 (a black circle appears). The modification coefficient C_{y} increases as the level control 46 moves farther in the right-hand direction.

In FIG. 21A, the designer of the software only needs to prepare, if known in advance, as the default value, an optimal value based on the result of the user test. In this case, it is only necessary that the level control 46 move to the default value when a default button 48 is pressed.

It should be noted that FIG. 21A shows an example where the perspective (1) is not distinguished from the perspective (2) above.

FIG. 21B shows an example where the modification coefficients (C₁, C₂) based on the perspective (1) and the modification coefficients (C₃, C₄) based on the perspective (2) can be adjusted independently. In the figure, an adjustment section described as “modification of wrist” indicate the modification based on the perspective (1), and an adjustment section described as “modification of gravity” indicate the modification based on the perspective (2).

FIG. 21C shows an example where a simple modification is possible. In

FIGS. 21A and 21B that show non-step adjustments, the task may be cumbersome for the user. However, in FIG. 21C, the user is capable of freely and easily selecting a desired adjustment specification from a number of kinds of adjustment specifications by marking the toggle 45.

By the methods respectively shown in FIGS. 21A to 21C, a movement amount ratio that takes into account a movability of the entire apparatus including a movability of wrists, elbows, and shoulders can be obtained.

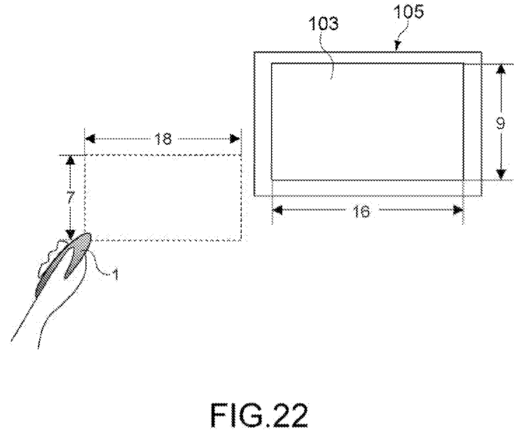

Another example of the user test different from the methods (a) to (e) above is a method as shown in FIG. 22. For example, the user moves the input apparatus 1 so as to draw a rectangle in such a range that the user feels ease in operating the input apparatus 1. At this time, the input apparatus 1 or the control apparatus 40 only needs to set the modification coefficients as follows. Specifically, the input apparatus 1 or the control apparatus 40 only needs to set such modification coefficients (Cₓ, C_{y}) that the movement amount ratio in the X- and Y-axis directions detected by the input apparatus 1 is converted into an aspect ratio of a screen 103 of a display apparatus 105. Therefore, the range in which the user feels ease in operating the input apparatus matches the range of the screen, thus improving the operational feeling of the user.

In a typical example, assuming that the aspect ratio of the screen 103 is 16:9 and the movement amount regarding the rectangle drawn in the user test in the X- and Y-axis directions is about 18:7, the modification coefficient Cₓ on the X axis is set to 16/18 (=8/9), and the modification coefficient C_{y} on the Y-axis is set to 9/7. In other words, the modification coefficients are set so that (Cₓ:C_{y})=(56:81) is established.

In the example shown in FIG. 22, the range of the screen 103 is described as a rectangle. However, the range of the screen 103 may be of any configuration including a square, other polygonal shapes, a circle, and an oval.

The embodiment of the present application is not limited to the above embodiment, and various other embodiments may be employed.

There is also a case where the input apparatus 1 (or input apparatus according to any other embodiment) includes the acceleration sensor unit 16 but does not include the angular velocity sensor unit 15. In this case, the velocity values (Vₓ, V_{y}) can be obtained in Step 103 by integrating the acceleration values (aₓ, a_{y}) detected by the acceleration sensor unit 16 (note that in this case, angular velocity values (ω_{ψ}, ω_{θ}) about the Y axis and X axis, respectively, cannot be obtained). Accelerations may be calculated by an image sensor instead of the acceleration sensor unit.

When calculating the radius gyrations as described above, a sensor for detecting the angular accelerations about the Y axis and X axis or a sensor for detecting angles may be used. In this case, the angular velocity values (ω_{ψ}, ω_{θ}) can be obtained by integrating the angular acceleration values detected by the angular acceleration sensor. Alternatively, the angular velocity values (ω_{ψ}, ω_{θ}) can be obtained by integrating the angle values detected by the angle sensor.

For a uniaxial angular acceleration sensor as the angular acceleration sensor described above, two uniaxial acceleration sensors disposed on the radius gyration are typically used. The angular velocity value of the input apparatus can be obtained by dividing a difference between the two acceleration values respectively obtained by the two acceleration sensors by a distance between the two acceleration sensors. As a biaxial angular acceleration sensor, it is only necessary that two biaxial acceleration sensors be used as in the detection principle of the two uniaxial acceleration sensors.

As the angle sensor, it is only necessary that the biaxial acceleration sensor be used so as to realize the principle for obtaining the roll angle φ as described above, for example. Therefore, it is only necessary that two biaxial acceleration sensors be used for detecting the angles about the two axes of the Y axis and X axis. Alternatively, an image sensor or a biaxial or triaxial magnetic sensor may be used for the angle sensor.

Next, an input apparatus according to another embodiment will be described.

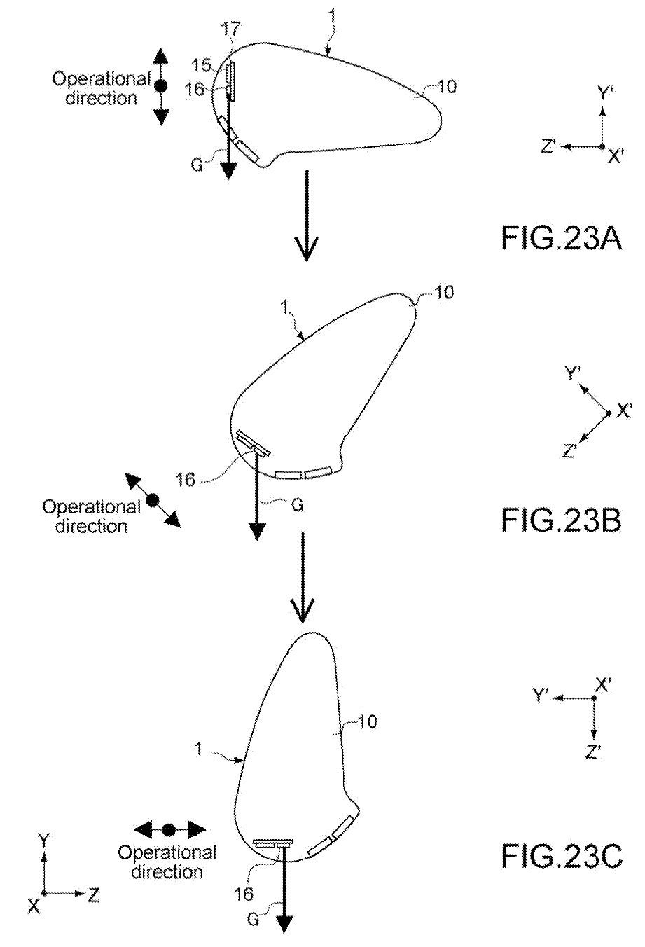

FIGS. 23A to 23C are side views each showing the input apparatus 1 during the process of a positional change. For example, there are cases where, during the operation of the input apparatus 1 within the X-Y plane (X′-Y′ plane), the input apparatus 1 is operated while tilted in the pitch direction as shown in FIG. 23B from the reference position as shown in FIG. 23A. There are also cases where the input apparatus 1 is operated while rotated by 90° in the pitch direction from the reference position, as shown in FIG. 23C. When such a positional change of the casing 10 with respect to the gravity direction (G) occurs, the gravitational effect to the acceleration sensor unit 16 changes. Moreover, the positional change of the casing 10 means that the user has changed the way of holding the casing 10, and thus the direction in which the operability is higher in terms of the bone structure changes. Therefore, due to the change in relationship between the operation direction and gravity direction of the input apparatus 1, the set modification coefficients (Cₓ, C_{y}) may not be optimal values, resulting in impairment of the operational feeling in moving the pointer 2 in the direction of the horizontal axis (X axis) and the direction of the vertical axis (Y axis) on the screen 3 (FIG. 5).

Specifically, in the example shown in FIG. 23A, the horizontal axis (X axis) of the screen 3 and a thickness direction (pitch axis (X′ axis) direction) of the casing 10 match, and the vertical axis (Y axis) of the screen 3 and a width direction (yaw axis (Y′ axis) direction) of the casing 10 match. In other words, the gravitational effect is larger when operating the input apparatus 1 in the vertical direction (pitch direction) than in the horizontal direction (yaw direction). Further, in the example shown in FIG. 23A, due to the bone structure, the operability of the input apparatus 1 is higher in the horizontal direction (yaw direction) than in the vertical direction (pitch direction) as shown in FIG. 10. In this case, as described above, the modification coefficients (Cₓ, C_{y}) to be multiplied to the velocity values (Vₓ, V_{y}) calculated based on the detection values of the sensor unit 17 are set so that Cₓ<C_{y} is established. Accordingly, by the modified velocity values (Vₓ′=CₓVₓ, V_{y}′=C_{y}V_{y}) being calculated and movement velocity signals of the pointer 2 based on the modified velocity values being generated by the control apparatus 40, isotropy in operability of the pointer 2 in the X- and Y-axis directions is secured.

Meanwhile, as shown in FIG. 23C, in a case where the casing 10 of the input apparatus 1 is tilted in the pitch direction and the vertical axis (Y axis) direction of the screen 3 and the yaw axis (Y′ axis) direction of the casing 10 are mutually orthogonal, the gravitational (G) effect is the same in both cases where the input apparatus 1 is operated in the pitch direction and where the input apparatus 1 is operated in the yaw direction. Therefore, because the operability of the pointer 2 in the X- and Y-axis directions becomes isotropic even without the multiplication of the modification coefficients, maintaining the setting of the modification coefficients (Cₓ<C_{y}) described above leads to deterioration in operational sense of the user.

Further, when the user holds the input apparatus 1 at an angle position rotated about the Z′ axis (roll axis) while in the position shown in FIG. 23B or 23C, due to the bone structure, isotropic operability can be obtained even when the modification coefficients are not multiplied.

Thus, the input apparatus 1 of this embodiment includes a compensation section for compensating the first and second modified velocity values (Vₓ′, V_{y}′) in relation to the positional change of the casing 10 with respect to the gravity direction (second compensation means or second compensation section). The compensation section is constituted of or executed by the control unit 30 (FIG. 3) of the input apparatus 1 including the MPU 19. Alternatively, the compensation section is constituted of or executed by the control apparatus 40 (FIG. 1) including the MPU 35.

For example, the MPU 19 is structured such that, when the position of the casing 10 of the input apparatus 1 is changed a shown in FIG. 23C, at least one of the first modified velocity value (Vₓ′=CₓVₓ) and the second modified velocity value (V_{y}′=C_{y}V_{y}) is multiplied by a predetermined compensation coefficient W so that Vₓ′ and V_{y}′ becomes isotropic. The compensation coefficient W can unlimitedly be set to any value. Accordingly, even when the input apparatus 1 is operated in the position as shown in FIG. 23C, the isotropic operability of the pointer 2 in the X- and Y-axis directions can be compensated.

In the example of FIG. 23, the compensation coefficient can be determined based on the change amount of the gravity acceleration G that acts in the Y′-axis direction. The change amount of the gravity acceleration G can be calculated based on the output of the second acceleration sensor 162 for detecting the acceleration in the Y′-axis direction. Alternatively, a third acceleration sensor for detecting an acceleration in the Z′-axis (roll axis) direction orthogonal to the X′- and Y′-axis directions may additionally be provided so that the positional change of the casing 10 with respect to the gravity direction is detected based on the output of the third acceleration sensor.

The compensation coefficient may be changed continuously or discretely in accordance with the change in gravity acceleration component acting in the Y′-axis direction. Alternatively, for simplifying the operation, for example, a certain compensation coefficient may be multiplied to the modified velocity value at a point when the input apparatus 1 reaches a certain pitch angle as shown in FIG. 23B.

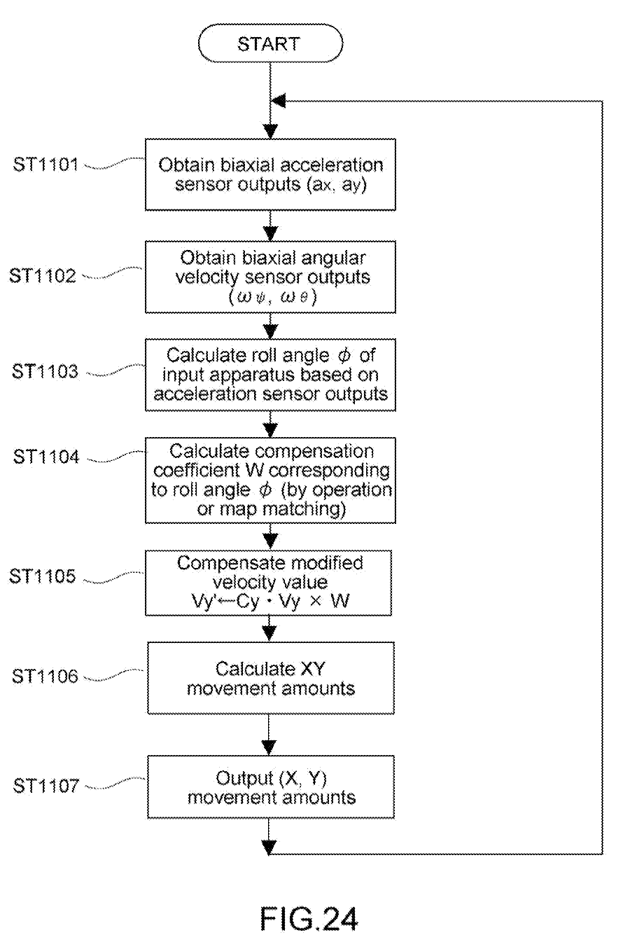

Also when the input apparatus 1 is rotated in the pitch direction accompanied by the roll movement, the compensation section can change the modified velocity values using the same operation. In this case, at least one of the first modified velocity value Vₓ′ and the second modified velocity value V_{y}′ is multiplied by the compensation coefficient corresponding to the roll angle and the pitch angle. FIG. 24 shows a specific example of control carried out by the control system 100 in this case.

First, as in Steps 101 and 102 of FIG. 9, the first and second acceleration sensors 161 and 162 obtain the acceleration values (aₓ, a_{y}) of the input apparatus 1 (casing 10), and the first and second angular velocity sensors 151 and 152 obtain the angular velocity values (ω_{ψ}, ω_{θ}) of the input apparatus 1 (Steps 1101 and 1102). Then, based on the obtained acceleration values and angular velocity values, the MPU 19 calculates the velocity values (Vₓ, V_{y}). Next, the MPU 19 calculates the roll angle φ as the rotational angle of the input apparatus 1 about the Z′ axis based on the output of the first and second acceleration sensors 161 and 162 (Step 1103). The roll angle can be calculated using, for example, Equation (5) below which has already been described above.

φ=arctan(aₓ/a_{y}) (5)

Subsequently, the MPU 19 calculates the compensation coefficient W corresponding to the calculated roll angle φ (Step 1104). As the compensation coefficient calculation method, the compensation coefficient for the X- and Y-axis directions can be calculated based on the velocities values in the respective directions in the coordinate system, which have been converted using a rotation matrix equation (Equation (6)) described with reference to FIG. 14. Alternatively, a method of reading set values from a correspondence table stored in the memory in advance based on the obtained velocity values in the coordinate system (map matching) may be employed.

Next, the MPU 19 multiplies the modified velocity value by the obtained compensation coefficient to thus calculate a compensation value of the modified velocity value that takes into account the change in direction of the gravity that acts on the input apparatus 1 (Step 1105). In the example shown in FIG. 24, descriptions have been given on the example where the compensation operation is conducted on the second modified velocity value V_{y}′ related to the movement velocity value of the pointer in the Y-axis direction. However, the compensation operation may of course be conducted on the first modified velocity value Vₓ′ related to the movement velocity value of the pointer in the X-axis direction.

Next, the control unit 30 transmits the compensated modified velocity values (Vₓ′, V_{y}′) to the control apparatus 40. The control apparatus 40 then calculates the movement amounts of the pointer 2 in the X- and Y-axis directions based on the received modified velocity values, and generates coordinate values (X(t), Y(t)) of the pointer 2 on the screen 3 (Steps 1106 and 1107). The processing above is the same as that of Steps 106 to 108 in FIG. 9.

Thus, it becomes possible to carry out the compensation operation of the modified velocity values that take into account the roll movement of the input apparatus 1. Moreover, the control flow above can similarly be applied to the case where the input apparatus 1 is not caused of the roll movement (φ=0). In the example above, the descriptions have been given on the example where the input apparatus 1 carries out the compensation operation on the modified velocity values. However, the control apparatus 40 may carry out the compensation operation of the modified velocity values.

Next, descriptions will be given on the method of producing the input apparatus 1.

As described above, for securing isotropy in operability of the pointer 2 in both the X- and Y-axis directions on the screen 3, the control system 100 obtains the modified movement values such as the modified velocity values by multiplying the modification coefficients that are different in the X- and Y-axis directions. For effectivity in operability of the pointer 2 based on those modified velocity values, it is necessary that the movement values (signals corresponding to the movement of the casing) calculated based on the detection values output from the sensor unit 17 that are not yet multiplied by the modification coefficients have the same sensitivity in both the X- and Y-axis directions. Thus, hereinafter, the method of producing the input apparatus 1 that involves an adjustment of the detection sensitivity of the sensor unit will be described. It should be noted that descriptions below are mainly made on a method of adjusting a sensitivity of the angular velocity sensor unit.

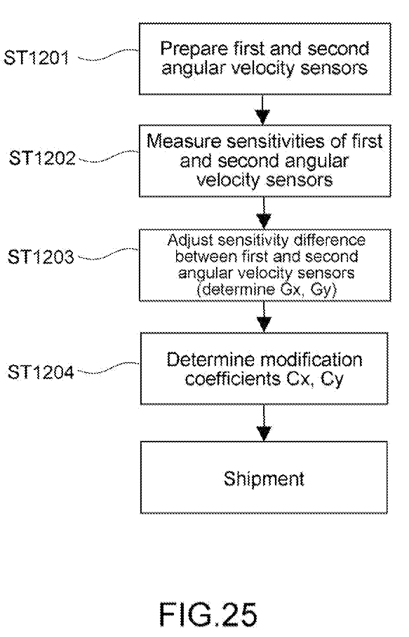

FIG. 25 shows a process flow for illustrating the method of producing an input apparatus according to this embodiment.

First, the first and second angular velocity sensors 151 and 152 that constitute the angular velocity sensor unit 15 are prepared (Step 1201). The first and second angular velocity sensors 151 and 152 may be dedicated to the input apparatus 1, or may be commercially-available general-purpose sensors. Further, commercially-available biaxial angular velocity sensors may be used for the angular velocity sensor unit 15.

Next, sensitivities of the prepared first and second angular velocity sensors 151 and 152 are measured (Step 1202). In addition to a case where the sensitivity of the angular velocity sensors is measured independently for each of the sensors, the sensitivity can also be measured in a state where the first and second angular velocity sensors 151 and 152 are packaged as the sensor unit 17 such that the first angular velocity sensor 151 can detect the angular velocity about the Y axis and the second angular velocity sensor 152 can detect the angular velocity about the X axis, or a state where the sensor unit 17 is mounted to the casing 10. Because the detection sensitivity of the angular velocity sensors fluctuates before and after being mounted on a substrate or being incorporated into an apparatus, by measuring the sensitivity in a process near the final process among all the processes required for the production of the input apparatus 1, it becomes possible to improve measurement precision.

Subsequently, the detection sensitivity of each of the sensors is adjusted so that a difference between the sensitivity of the first angular velocity sensor 151 and that of the second angular velocity sensor 152 becomes a predetermined value or less (Step 1203). Ideally, the predetermined value is 0, but in actuality, the value may be a value that is substantially 0. The adjustment of a detection sensitivity difference means determining a gain (Gx or Gy) for compensating the sensitivity difference, the gain being multiplied to an output of at least one of the first and second angular velocity sensors 151 and 152. The determined gains (Gx, Gy) may be stored in the memory of the MPU 19 to be multiplied to the movement values together with the modification coefficients (Cₓ, C_{y}) in calculating the velocity values of the pointer.

It is also possible to multiply the gain (Gx or Gy) to at least one of the angular velocity values of the first and second angular velocity sensors 151 and 152. When the sensitivity variation of the angular velocity sensors is as large as ±20%, the sensitivity adjustment becomes essential for preventing the effect of the modification coefficients from being buried in the sensitivity difference between the sensors. In contrast, when the sensitivity variation is small, it is possible to omit the above process.

Next, the modification coefficients (Cₓ, C_{y}) are determined and values are stored in the memory of the MPU 19 (Step 1204). The modification coefficients are respectively multiplied to the velocity values (Vₓ, V_{y}) of the casing 10 in the X- and Y-axis directions calculated based on the outputs of the first and second angular velocity sensors 151 and 152, to thus calculate the respective modified velocity values (Vₓ′, V_{y}′) of the pointer 2. In this example, the modification coefficients are set in the input apparatus 1 as default values.

The gains (Gx, Gy) and the modification coefficients (Cₓ, C_{y}) may be determined by an operator or may be calculated by the operational processing of the MPU 19. In this embodiment, because the sensitivity difference between the first and second angular velocity sensors 151 and 152 is adjusted to be the predetermined value or less, the gains generated by the set modification coefficients can be prevented from being buried in the sensitivity difference between the sensors. Accordingly, the modification operation of the movement velocity of the pointer using the modification coefficients can be made effective, with the result that the input apparatus 1 with high usability and excellent operability can be provided. Furthermore, values obtained by multiplying the gains (Gx, Gy) by the modification coefficients (Cₓ, C_{y}) (GxCₓ, GyC_{y}) may be stored in the memory of the MPU 19 as the modification coefficients with the sensitivity variation adjusted.

Hereinafter, descriptions will be given on some specific examples of an angular velocity sensor correction (calibration) method.

(Example of Correction of Angular Velocity Sensors by Adjustment of Amplifier Circuit)

The adjustment of the detection sensitivity of the angular velocity sensors, that is, the correction of the angular velocity sensors can be realized by, for example, adjusting a signal processing circuit through which outputs of the angular velocity sensors pass to be supplied to the MPU 19. Specifically, the adjustment of the detection sensitivity of the angular velocity sensors becomes possible by adjusting an amplification rate of the amplifier circuit that amplifies the outputs of the angular velocity sensors.

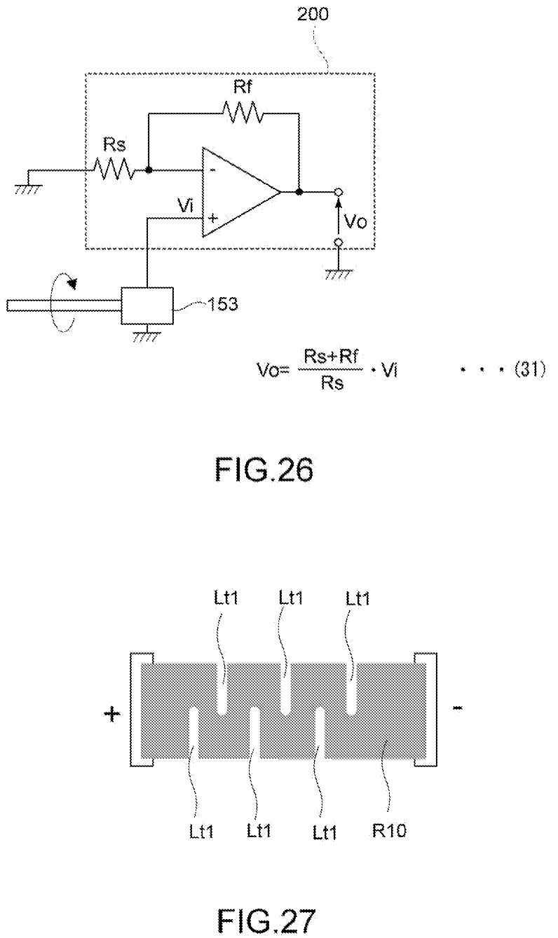

Now, descriptions will be given on a case where an operational amplifier circuit 200 as shown in FIG. 26 is used for an amplifier circuit of angular velocity sensors. An output of an angular velocity sensor 153 is amplified by the operational amplifier circuit 200. The sensors (or sensor unit or input apparatus) are rotated or oscillated about the X axis and Y axis so that a difference between the outputs of the sensors is measured, thereby measuring the sensitivity difference between the angular velocity sensors. By adjusting the amplification rate (gain) G of the operational amplifier circuit 200 for each of the angular velocity sensors, the sensitivity difference between those sensors can be adjusted.

Here, the amplification rate G of the operational amplifier circuit 200 is provided by Equation (16) below. Vo represents an output voltage of the operational amplifier circuit 200, and Vi represents an input voltage to a non-inversion input terminal, Vi also being an output of the angular velocity sensor 153. Rs represents a resistance value of a resistor Rs connected to the non-inversion input terminal, and Rf represents a resistance value of a feedback resistor Rf connected between the non-inversion input terminal and the output terminal.

G=Vo/Vi=(Rs+Rf)/Rs (16)

By the adjustment of the resistance values Rs and Rf, G can be changed arbitrarily. As a resistance value adjustment method, there is, in addition to a method of constituting the resistors by variable resistors, a method of trimming resistor elements by laser beams, the example of which is shown in FIG. 27. In the laser trimming, process traces Lt1 that partially melt down a strip-like resistor element RIO are formed so that the resistance values change. Thus, it becomes possible to easily adjust the resistance values to desired values depending on the number, length, width, pattern shape, and the like of process traces Lt1.

(Example of Correction of Angular Velocity Sensors by Adjustment of Vibration Characteristics)

As another example of the adjustment of output sensitivities of the angular velocity sensors, there is a method of changing characteristics of the angular velocity sensors themselves. In a case of vibration gyro sensors, the detection sensitivity of the angular velocity sensors can arbitrarily be changed by adjusting vibration characteristics of a vibrator.

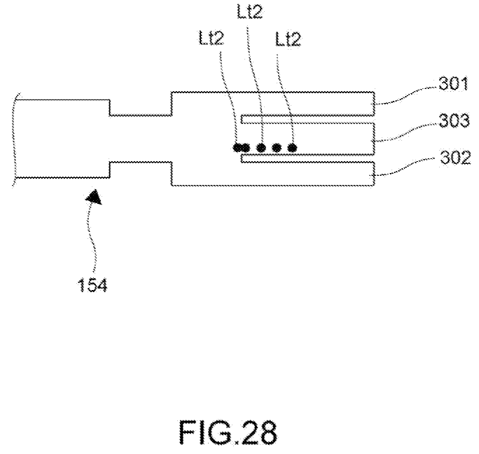

FIG. 28 shows an example of a tuning-fork-type gyro sensor. A gyro sensor 154 includes three vibrators 301 to 303, and the two vibrators 301 and 302 on both sides vibrate at a phase opposite to the vibrator 303 in the middle. In addition, a detection electrode for detecting Coriolis force is formed on an arbitrary one of the three vibrators, and an angular velocity signal is generated based on a detection signal from the detection electrode.

In the gyro sensor 154 of this type, a resonance frequency, detuning frequency, and the like of the vibrator can be changed by forming process traces Lt2 on a surface of the vibrator using laser beams. The detuning frequency is expressed by a difference of a driving resonance frequency and a detecting resonance frequency, and a sensitivity, that is, gain of the gyro sensor 154 is adjusted by changing the detuning frequency. Therefore, by carrying out the processing described above on one or both of the angular velocity sensors based on the detection sensitivity difference between the two angular velocity sensors, it becomes possible to suppress the sensitivity difference between the sensors within a predetermined range. The sensor sensitivity adjustment method as described above can be carried out after the angular velocity sensors are mounted on the substrate or before the sensors are incorporated into the casing 10.

(Example of Correction of Angular Velocity Sensors by Internal Operation)

Next, descriptions will be given on a method of adjusting the sensitivity of the angular velocity sensors (correction method) after the angular velocity sensor unit is incorporated into the casing to thus constitute the input apparatus.

In the correction of the angular velocity sensors after constituting the input apparatus 1, the input apparatus is rotated or oscillated in the yaw direction (rotational direction about the X axis) and the pitch direction (rotational direction about the Y axis), the detection sensitivity difference is adjusted based on the detection values of the angular velocity sensors obtained at that time. This task is carried out by the correction processing operation made on the input apparatus by an operator (manufacturer) prior to a shipment of the input apparatus.

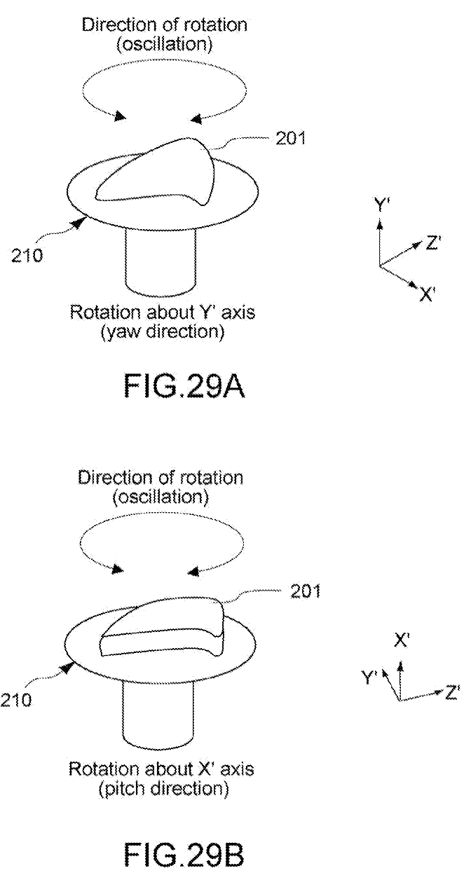

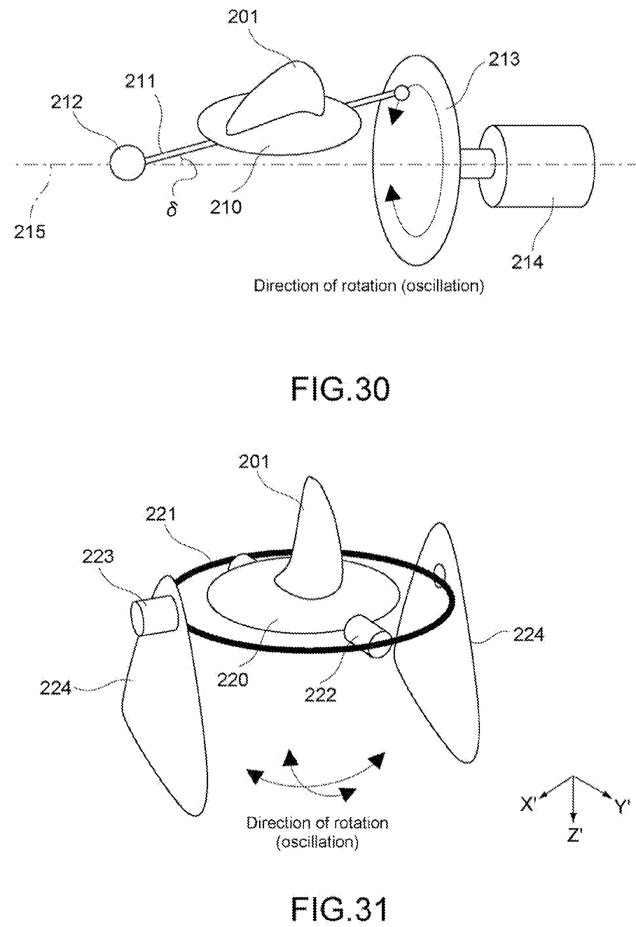

FIG. 29 schematically show processes of measuring the detection sensitivities of the angular velocity sensors of the input apparatus in the yaw and pitch directions. The input apparatus described herein is not yet complete, which means that sensitivities of the angular velocity sensors are not yet set. Thus, reference numeral 201 is assigned to the input apparatus so as to distinguish the incomplete input apparatus from the completed input apparatus 1 (the same applies to FIGS. 30 and 31).

The input apparatus 201 is mounted on a rotary table 210. The rotary table 210 is rotated (or oscillated) at a known rotational velocity, and output sensitivities of the angular velocity sensors in the yaw and pitch directions are then measured. FIG. 29A shows an example where the detection sensitivity of the input apparatus 201 in the yaw direction is measured by mounting the input apparatus 201 on the rotary table 210 so that the yaw axis (Y′ axis) thereof becomes vertical. FIG. 29B shows an example where the detection sensitivity of the input apparatus 201 in the pitch direction is measured by mounting the input apparatus 201 on the rotary table 210 so that the pitch axis (X′ axis) thereof becomes vertical.

When rotating the rotary table 210 at a constant velocity, the detection values of the angular velocity sensors become constant values. In this case, by referencing the detection values in the yaw and pitch directions as they are, the sensitivity difference between the angular velocity sensors regarding the yaw and pitch directions can be obtained. Moreover, when oscillating the rotary table 210 at a constant cycle, the detection values of the angular velocity sensors exhibit a sinusoidal curve. In this case, by referencing a peak value of the curve, the sensitivity difference between the angular velocity sensors regarding the yaw and pitch directions can be obtained.

After measuring the sensitivity difference between the yaw and pitch directions, the MPU 19 (or operator) calculates the gain for suppressing the sensitivity difference at a predetermined level or less, and stores the calculated gain in a nonvolatile memory of the MPU 19. The gain is used in calculating the velocity values (Vₓ, V_{y}) of the casing 10 obtained based on the output values of the sensor unit 17 when the user normally operates the input apparatus. Therefore, by setting a gain such that the obtained sensitivity difference can be compensated, it becomes possible to realize the calculation of velocity values not affected by the sensitivity difference.

FIG. 30 shows a structural example of a measurement jig for measuring the detection sensitivities of the angular velocity sensors in the yaw and pitch directions at the same time. The input apparatus 201 is mounted on a support table 210. The support table 210 includes a linear oscillation axis 211. One end of the oscillation axis 211 is fixed to a rotary plate 213 at an eccentric position different from a center thereof in such a manner that the oscillation axis 211 can freely oscillate in all directions, whereas the other end of the oscillation axis 211 is fixed to a stationary section 212 positioned on a reference line 215 that passes a rotational center of the rotary plate 213 in such a manner that the oscillation axis 211 can freely oscillate in all directions.

Upon rotating (or oscillating) the rotary plate 213 by driving a motor 214, the input apparatus 201 rotates like a conical pendulum while maintaining a certain angle δ between the oscillation axis 211 and the reference line 215. Therefore, by setting the reference line 215 at an arbitrary angle (e.g., in vertical or horizontal direction), it becomes possible to measure the detection sensitivities of the angular velocity sensors of the input apparatus 201 in the yaw and pitch directions at the same time.

FIG. 31 shows another structural example of a measurement jig capable of measuring the detection sensitivities of the angular velocity sensors in the yaw and pitch directions at the same time. A support table 220 that supports the input apparatus 201 is axially supported by a ring-shape frame member 221 and is structured so as to be rotatable (or capable of freely oscillating) in the yaw direction (about the Y′ axis) of the input apparatus 201 by driving of a first motor 222 disposed on a support axis of the frame member 221. In addition, the frame member 221 is axially supported by bases 224 and is structured so as to be rotatable (or capable of freely oscillating) in the pitch direction (about the X′ axis) of the input apparatus 201 by driving of a second motor 223 disposed on the support axis thereof. The rotational axis of the support table 220 and that of the frame member 221 are mutually orthogonal.

The input apparatus 201 is mounted on the support table 220 such that the yaw axis (Y′ axis) direction and pitch axis (X′ axis) direction thereof respectively face a rotational-axis direction of the support table 220 and that of the frame member 221. Moreover, by simultaneously driving the first and second motors 222 and 223, the input apparatus 201 rotates (or oscillates) in the yaw and pitch directions. Accordingly, the detection sensitivities of the angular velocity sensors of the input apparatus 201 in the yaw and pitch directions can be measured at the same time.

Further, the roll axis of the input apparatus 201 becomes parallel to the vertical direction at a rotational position at which the support table 220 becomes horizontal within the X′-Y′ plane. Therefore, using the fact that the acceleration detection value of the acceleration sensor unit 16 becomes 0 at this position, it is also possible to carry out the correction of the acceleration sensor unit 16.

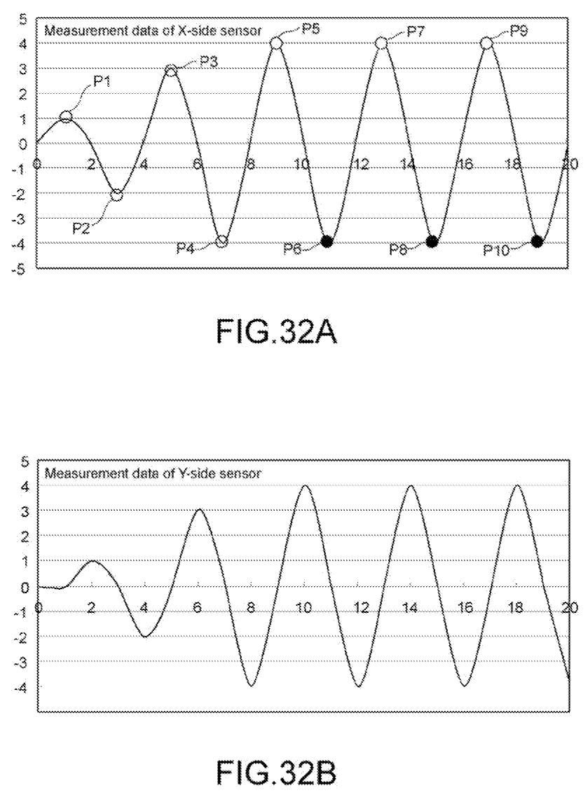

FIG. 32 are schematic diagrams each showing a detection example of an angular velocity in the input apparatus 201. FIG. 32A shows measurement data of an angular velocity sensor for detection in the yaw direction (X-side sensor), and FIG. 32B shows measurement data of an angular velocity sensor for detection in the pitch direction (Y-side sensor). In the figures, the abscissa axis represents time (arbitrarily-set scale) and the ordinate axis represents a detection voltage (arbitrarily-set scale). The measurement data of FIG. 32 respectively show output examples of the sensors when the input apparatus 201 is oscillated simultaneously in the yaw and pitch directions. Therefore, output levels of the sensors change sinusoidally, and output waveforms of the sensors have a phase difference of 90 degrees.

The correction of the angular velocity sensor for detection in the yaw direction is carried out as follows, for example. This task may be carried out by the MPU 19 mounted to the input apparatus 201, or may be carried out by other computers connected to the input apparatus 201.

Regarding the X-side sensor, first, peak values (P1 to P10) of the output waveform obtained after the start of the measurement are detected. The obtained pieces of peak data are sorted, and several pieces of low-order data (in this example, peak values P1 to P4 obtained immediately after the start of the measurement) are excluded therefrom. If necessary, several pieces of high-order data may be excluded from the obtained pieces of peak data. Subsequently, among the obtained peak values, a positive representative value (average value) is obtained from positive pieces of data (P5, P7, and P9 in the example shown in the figure), and a negative representative value (average value) is obtained from negative pieces of data (P6, P8, and P10 in the example shown in the figure).

Also with respect to the Y-side sensor, the positive representative value and negative representative value of the sensor outputs are obtained by the same method as above.

Subsequently, based on the obtained positive and negative representative values of the outputs of the X- and Y-side sensors, gains (Gx, Gy) on the X and Y sides, respectively, that are used for adjusting the sensitivity difference between the sensors are determined (Step 1203 of FIG. 25). Each of the gains can be calculated by, for example, dividing an output reference value (reference value) of the sensor prepared in advance by a difference between the positive and negative representative values. The calculation of the gain is carried out for each of the X- and Y-side sensors. As another example, the gain Gx or Gy to be multiplied to the corresponding one of the X- and Y-side sensors can be calculated based on a ratio of a difference between the positive and negative representative values of the X-side sensor and a difference between the positive and negative representative values of the Y-side sensor.

The output gains of the X- and Y-side angular velocity sensors determined as described above are stored in the nonvolatile memory of the MPU 19. After that, predetermined modification coefficients (Cₓ, C_{y}) are similarly stored in the nonvolatile memory of the MPU 19 (Step 1204 of FIG. 25). A completed input apparatus 1 in which predetermined operational data is stored in the MPU 19 is thus produced.

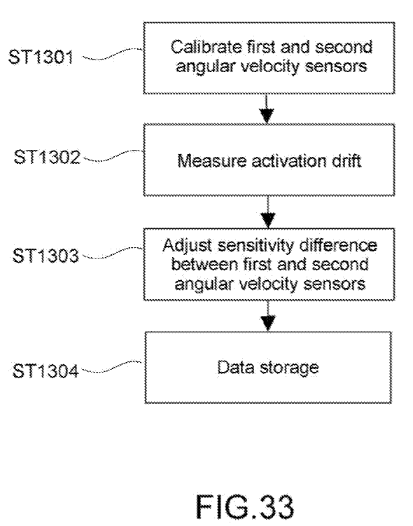

FIG. 33 shows a schematic process flow of a procedure of modifying the sensors of the input apparatus 201. Here, descriptions will be given on an example where the sensors are modified using the measurement jig shown in FIG. 31.

Power of the input apparatus 201 is turned on in a state where a predetermined operation key for starting the correction of the sensor unit 17 is pressed. Accordingly, the MPU 19 executes a correction mode described below.

(1) Zero-Point Correction of Sensors (Step 1301)

The MPU 19 stands by until a predetermined time passes since the power is turned on. During the standby, the operator mounts the input apparatus 201 on the support table 220 such that the roll axis (Z′ axis) of the input apparatus 201 becomes vertical. The support table 220 is maintained in a static state. After an elapse of the predetermined time, the MPU 19 executes a zero-point correction of the acceleration sensor unit 16. In this state, because the detection axes of the first and second acceleration sensors 161 and 162 (X′ axis, Y′ axis) that constitute the acceleration sensor unit 16 are orthogonal to the vertical direction, it becomes possible to carry out the zero-point correction of the first and second acceleration sensors 161 and 162 with high precision.

The MPU 19 then executes the correction of the angular velocity sensor unit 15. When the input apparatus 201 is in the static state, the outputs of the angular velocity sensors are constant. The angular velocity sensors like vibration gyro sensors output the angular velocity detection values as values relative to reference potentials. Therefore, the angular velocity sensors in the static state output only potentials corresponding to the reference potentials. Thus, the MPU 19 stores the output potentials as the reference potentials.

(2) Measurement of Activation Drift (Step 1302)

Next, the MPU 19 measures an activation drift of the angular velocity sensors. The activation drift is an output drift of the angular velocity sensors that appears until a certain time passes after the power is turned on. The activation drift may cause an erroneous movement of the pointer 2 when the input apparatus is operated right after the power is turned on. Thus, the MPU 19 samples time shifts of drift amounts to make reference thereto when calculating the movement velocity values of the pointer.

(3) Adjustment of Sensitivity Difference Between Angular Velocity Sensors (Step 1303)

Subsequently, a measurement of detection sensitivities of the angular velocity sensors in the yaw and pitch directions of the input apparatus 201 and an adjustment of the detection sensitivity difference between the angular velocity sensors are carried out. In this example, output sensitivities of the angular velocity sensors in both directions are measured by causing the support table 220 to rotate or oscillate in both the yaw and pitch directions by the driving of the motors 222 and 223. After the measurement, the gains (Gx, Gy) with which the sensitivity difference becomes a predetermined value or less are determined by the method as described above, for example.

Moreover, it is also possible to detect reference potentials of the angular velocity sensors based on the output waveforms of the angular velocity sensors shown in FIG. 32. In other words, while an intermediate value between the positive peak value and negative peak value of each of the angular velocity sensors is assumed as a center value of the output potential, the center value of each of the sensors can be judged as the reference potential thereof.

(4) Data Storage (Step 1304)

Finally, the gains (Gx, Gy) are stored in the nonvolatile memory of the MPU 19. The modification coefficients (Cₓ, C_{y}) for making the operability of the pointer 2 isotropic in the X- and Y-axis directions may also be stored in the MPU 19.

The input apparatuses according to the above embodiments are embodied in forms that wirelessly transmit input information to the control apparatus. However, the input information may be transmitted via wires.

The embodiments may be applied to, for example, a handheld-type information processing apparatus (handheld apparatus) including a display section. In this case, a pointer displayed on the display section is moved by the user moving a main body of the hand-held apparatus. Examples of the hand-held apparatus include a PDA (Personal Digital Assistance), a cellular phone, a portable music player, and a digital camera.

In the above embodiments, the pointer 2 that moves on the screen in accordance with the movement of the input apparatus 1 is expressed as an image of an arrow. However, the image of the pointer 2 is not limited to the arrow and may simply be a circle, square, and the like, or a character image or other images.

The detection axes of the angular velocity sensor unit 15 and acceleration sensor unit 16 included in the sensor unit 17 do not necessarily have to be mutually orthogonal like the X′ axis and the Y′ axis. In that case, accelerations projected in directions of the orthogonal axes can be calculated using a trigonometric function. Similarly, angular velocities about the respective orthogonal axes can be calculated using the trigonometric function.

Regarding the sensor unit 17 described in the above embodiments, the descriptions have been given on the case where the detection axes of the angular velocity sensor unit 15 on the X′ axis and Y′ axis and the detection axes of the acceleration sensor unit 16 on the X′ axis and Y′ axis match, respectively. However, the detection axes do not necessarily have to match between the sensors. For example, when the angular velocity sensor unit 15 and the acceleration sensor unit 16 are mounted on a substrate, the angular velocity sensor unit 15 and the acceleration sensor unit 16 may be mounted while being deviated by a predetermined rotational angle within a main surface of the substrate so that the detection axes of the sensor units do not match. In this case, the accelerations and angular velocities on the respective axes can be calculated using the trigonometric function.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A three-dimensional operation input apparatus controlling a pointer on a screen, comprising:
a casing;
a sensor to detect a three-dimensional movement of the casing;
a movement value calculation section to calculate, based on a detection value detected by the sensor, a first movement value corresponding to the movement of the casing in a direction along a first axis and a second movement value corresponding to the movement of the casing in a direction along a second axis orthogonal to the first axis; and
a modification section to calculate a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient.

2. The three-dimensional operation input apparatus according to claim 1,
wherein the modification section sets, when the first direction on the screen is a lateral direction on the screen and the second direction on the screen is a longitudinal direction on the screen, the second modification coefficient to be larger than the first modification coefficient.

3. The three-dimensional operation input apparatus according to claim 2,
wherein the screen has an aspect ratio of 16:9 or less.

4. The three-dimensional operation input apparatus according to claim 1,
wherein the sensor detects a gravity direction in addition to the movement of the casing,
wherein the movement value calculation section calculates the second movement value while assuming that the gravity direction is the direction along the second axis, and calculates the first movement value while assuming that a direction perpendicular to the gravity direction is the direction along the first axis, and
wherein the modification section sets the second modification coefficient to be larger than the first modification coefficient.

5. The three-dimensional operation input apparatus according to claim 1,
wherein the movement value calculation section calculates the first movement value while assuming that a direction in which a width of the screen is longer is the direction along the first axis, and calculates the second movement value while assuming that a direction in which the width of the screen is shorter is the direction along the second axis, and
wherein the modification section sets the first modification coefficient to be larger than the second modification coefficient.

6. The three-dimensional operation input apparatus according to claim 5,
wherein the screen has an aspect ratio of 2:1 or more.

7. The three-dimensional operation input apparatus according to claim 1, further comprising
a first compensation section to compensate a sensitivity variation of the sensor that is related to the calculation of the first movement value and the second movement value.

8. The three-dimensional operation input apparatus according to claim 1, further comprising
an adjustment section to adjust at least one of the first modification coefficient and the second modification coefficient.

9. The three-dimensional operation input apparatus according to claim 1, further comprising
a second compensation section to compensate at least one of the first modified movement value and the second modified movement value in relation to a positional change of the casing with respect to a gravity direction.

10. A control apparatus controlling a pointer on a screen in accordance with a detection value transmitted from a three-dimensional operation input apparatus that includes a casing and a sensor to detect a three-dimensional movement of the casing, the control apparatus comprising:
a reception section to receive the detection value;
a movement value calculation section to calculate, based on the detection value, a first movement value corresponding to the movement of the casing in a direction along a first axis and a second movement value corresponding to the movement of the casing in a direction along a second axis orthogonal to the first axis;
a modification section to calculate a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient; and
a coordinate information generation section to generate coordinate information of the pointer on the screen in accordance with the first modified movement value and the second modified movement value.

11. A control apparatus controlling a pointer on a screen in accordance with a calculation value transmitted from a three-dimensional operation input apparatus that includes a casing, a sensor to detect a three-dimensional movement of the casing, and a movement value calculation section to calculate, based on a detection value detected by the sensor, a first movement value corresponding to the movement of the casing in a direction along a first axis and a second movement value corresponding to the movement of the casing in a direction along a second axis orthogonal to the first axis, the control apparatus comprising:
a reception section to receive the calculation value;
a modification section to calculate a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient; and
a coordinate information generation section to generate coordinate information of the pointer on the screen in accordance with the first modified movement value and the second modified movement value.

12. The control apparatus according to claim 11, further comprising
an adjustment section to adjust at least one of the first modification coefficient and the second modification coefficient.

13. A control system controlling a pointer on a screen, the control system comprising:
a three-dimensional operation input apparatus including
a casing,
a sensor to detect a three-dimensional movement of the casing,
a movement value calculation section to calculate, based on a detection value detected by the sensor, a first movement value corresponding to the movement of the casing in a direction along a first axis and a second movement value corresponding to the movement of the casing in a direction along a second axis orthogonal to the first axis,
a modification section to calculate a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient, and
a transmission section to transmit the first modified movement value and the second modified movement value as input information; and
a control apparatus including
a reception section to receive the input information, and
a coordinate information generation section to generate coordinate information of the pointer on the screen in accordance with the first modified movement value and the second modified movement value.

14. A control system controlling a pointer on a screen, the control system comprising:
a three-dimensional operation input apparatus including
a casing,
a sensor to detect a three-dimensional movement of the casing, and
a transmission section to transmit a detection value detected by the sensor; and
a control apparatus including
a reception section to receive the detection value,
a movement value calculation section to calculate, based on the detection value, a first movement value corresponding to the movement of the casing in a direction along a first axis and a second movement value corresponding to the movement of the casing in a direction along a second axis orthogonal to the first axis,
a modification section to calculate a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient, and
a coordinate information generation section to generate coordinate information of the pointer on the screen in accordance with the first modified movement value and the second modified movement value.

15. A control system controlling a pointer on a screen, the control system comprising:
a three-dimensional operation input apparatus including
a casing,
a sensor to detect a three-dimensional movement of the casing,
a movement value calculation section to calculate, based on a detection value detected by the sensor, a first movement value corresponding to the movement of the casing in a direction along a first axis and a second movement value corresponding to the movement of the casing in a direction along a second axis orthogonal to the first axis, and
a transmission section to transmit the values calculated by the movement value calculation section; and
a control apparatus including
a reception section to receive the calculation values,
a modification section to calculate a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient, and
a coordinate information generation section to generate coordinate information of the pointer on the screen in accordance with the first modified movement value and the second modified movement value.

16. A control method, comprising:
outputting a first detection value by detecting a movement of a casing of a three-dimensional operation input apparatus in a direction along a first axis;
outputting a second detection value by detecting the movement of the casing in a direction along a second axis orthogonal to the first axis;
calculating, based on the first detection value and the second detection value, a first movement value corresponding to the movement of the casing in the direction along the first axis and a second movement value corresponding to the movement of the casing in the direction along the second axis;
calculating a first modified movement value for moving a pointer in a first direction on a screen corresponding to the first axis, the first modified movement value obtained by multiplying the first movement value by a first modification coefficient;
calculating a second modified movement value for moving the pointer in a second direction on the screen corresponding to the second axis, the second modified movement value obtained by multiplying the second movement value by a second modification coefficient different from the first modification coefficient; and
generating coordinate information of the pointer on the screen in accordance with the first modified movement value and the second modified movement value.

17. A method of producing a three-dimensional operation input apparatus, the method comprising:
storing, by a first storage section, a first modification coefficient that is multiplied by a first movement value calculated based on a detection value of a first sensor to detect a movement of a casing in a direction along a first axis, the first movement value corresponding to the movement of the casing in the direction along the first axis, to thus calculate a first modified movement value for moving a pointer in a first direction on a screen corresponding to the first axis;
storing, by a second storage section, a second modification coefficient different from the first modification coefficient, that is multiplied by a second movement value calculated based on a detection value of a second sensor to detect the movement of the casing in a direction along a second axis orthogonal to the first axis, the second movement value corresponding to the movement of the casing in the direction along the second axis, to thus calculate a second modified movement value for moving the pointer in a second direction on the screen corresponding to the second axis;
measuring a first detection sensitivity as a detection sensitivity of the first sensor and a second detection sensitivity as a detection sensitivity of the second sensor; and
storing, respectively by a third storage section and a fourth storage section, a first gain and a second gain respectively multiplied to the first movement value and the second movement value for respectively adjusting the first detection sensitivity and the second detection sensitivity so that a difference between the first detection sensitivity and the second detection sensitivity becomes a predetermined value or less.

18. The method of producing a three-dimensional operation input apparatus according to claim 17, further comprising:
storing, by the first storage section, a value obtained by multiplying the first modification coefficient by the first gain; and
storing, by the second storage section, a value obtained by multiplying the second modification coefficient by the second gain.

19. The method of producing a three-dimensional operation input apparatus according to claim 17,
wherein the first sensor and the second sensor are incorporated to the casing,
wherein the first detection sensitivity is measured by one of rotating and oscillating the casing about the second axis, and
wherein the second detection sensitivity is measured by one of rotating and oscillating the casing about the first axis.

20. A handheld apparatus controlling a movement of a pointer displayed on a screen, the handheld apparatus comprising:
a casing;
a display section displaying the screen;
a sensor to detect a three-dimensional movement of the casing;
a movement value calculation section to calculate, based on a detection value detected by the sensor, a first movement value corresponding to the movement of the casing in a direction along a first axis and a second movement value corresponding to the movement of the casing in a direction along a second axis orthogonal to the first axis; and
a modification section to calculate a first modified movement value for moving the pointer in a first direction on the screen corresponding to the first axis, the first modified movement value obtained by multiplying the first movement value by a first modification coefficient, and a second modified movement value for moving the pointer in a second direction on the screen corresponding to the second axis, the second modified movement value obtained by multiplying the second movement value by a second modification coefficient different from the first modification coefficient.
